(19) United States
(12) Patent Application Publication
(10) Pub. No.: US 2026/0180846 A1
(43) Pub. Date: Jun. 25, 2026

(54) ELECTRONIC DEVICE AND METHOD FOR FAST FOURIER TRANSFORM

(71) Applicant: Samsung Electronics Co., Ltd., Suwon-si (KR)

(72) Inventors: Jihoon HAN, Suwon-si (KR); Daeho SOHN, Suwon-si (KR); Moonheok JANG, Suwon-si (KR)

(21) Appl. No.: 19/538,387

(22) Filed: Feb. 12, 2026

Related U.S. Application Data
(63) Continuation of application No. PCT/KR2024/009961, filed on Jul. 11, 2024.

(30) Foreign Application Priority Data
Aug. 19, 2023 (KR) 10-2023-0108662
Sep. 25, 2023 (KR) 10-2023-0128190

(51) Int. Cl. H04L 27/26

(52) U.S. Cl. CPC H04L 27/2651; H04L 27/2613; H04L 27/2647

(57) ABSTRACT

An electronic device is provided. The electronic device includes memory, and at least one processing circuit for orthogonal frequency division multiplexing (OFDM) modulation for changing the domain of a symbol sequence from a first domain to a second domain, wherein the at least one processing circuit is configured to obtain a first symbol sequence related to the first domain, obtain a second symbol sequence related to the second domain by performing, on the first symbol sequence, an inverse fast Fourier transform (IFFT) operation using a cyclic shift operation on the first symbol sequence, and generate a transmission signal by performing a cyclic extension operation on the basis of the second symbol sequence, and wherein, for each fast Fourier transform (FFT) index of a plurality of FFT indexes according to an FFT size, the IFFT operation using the cyclic shift operation comprises an operation to change a value of the most significant bit (MSB) of a bit sequence of a corresponding FFT index from 0 to 1 or 1 to 0.

### CROSS-REFERENCE TO RELATED APPLICATION(S)

This application is a continuation application, claiming priority under 35 U.S.C. § 365 (c), of an International application No. PCT/KR2024/009961, filed on Jul. 11, 2024, which is based on and claims the benefit of a Korean patent application number 10-2023-0108662, filed on Aug. 19, 2023, in the Ministry of Intellectual Property (MOIP), and of a Korean patent application number 10-2023-0128190, filed on Sep. 25, 2023, in the Ministry of Intellectual Property (MOIP), the disclosure of each of which is incorporated by reference herein in its entirety.

### BACKGROUND

### 1. Field

The disclosure relates to an electronic device and a method for a fast Fourier transform.

### 2. Description of Related Art

In a wireless communication system, when receiving a signal, a fast Fourier transform (FFT) operation is used to change a sequence for a time domain to a sequence for a frequency domain. When transmitting a signal, to prevent inter channel interference, a cyclic extension operation is used to insert a cyclic prefix (CP) into the signal.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method for a fast Fourier transform.

Additional aspects will be set forth in part in the description which follows and, in part, will be apparent from the description, or may be learned by practice of the presented embodiments.

In accordance with an aspect of the disclosure, an electronic device is provided. The electronic device includes memory, and at least one processing circuit for orthogonal frequency division multiplexing (OFDM) modulation to change a domain of a symbol sequence from a first domain to a second domain, wherein the at least one processing circuit is configured to obtain a first symbol sequence related to the first domain, obtain a second symbol sequence related to the second domain by performing an inverse fast Fourier transform (IFFT) operation using a cyclic shift operation on the first symbol sequence, and generate a transmission signal by performing a cyclic extension operation on the second symbol sequence, and wherein, for each fast Fourier transform (FFT) index of a plurality of FFT indexes according to an FFT size, the IFFT operation using the cyclic shift operation includes an operation to change a value of the most significant bit (MSB) of a bit sequence of a corresponding FFT index from 0 to 1 or 1 to 0.

In accordance with another aspect of the disclosure, a method performed by an electronic device is provided. The method includes obtaining, by the electronic device, a first symbol sequence related to a first domain, obtaining, by the electronic device, a second symbol sequence related to a second domain by performing an inverse fast Fourier transform (IFFT) operation using a cyclic shift operation on the first symbol sequence, and generating, by the electronic device, a transmission signal by performing a cyclic extension operation on the second symbol sequence, wherein, for each fast Fourier transform (FFT) index of a plurality of FFT indexes according to an FFT size, the IFFT operation using the cyclic shift operation includes an operation to change a value of the most significant bit (MSB) of a bit sequence of a corresponding FFT index from 0 to 1 or 1 to 0.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include obtaining, by the electronic device, a first symbol sequence related to a first domain, obtaining, by the electronic device, a second symbol sequence related to a second domain by performing an inverse fast Fourier transform (IFFT) operation using a cyclic shift operation on the first symbol sequence, and generating, by the electronic device, a transmission signal by performing a cyclic extension operation on the second symbol sequence, wherein, for each fast Fourier transform (FFT) index of a plurality of FFT indexes according to an FFT size, the IFFT operation using the cyclic shift operation comprises an operation to change a value of the most significant bit (MSB) of a bit sequence of a corresponding FFT index from 0 to 1 or 1 to 0.

In accordance with another aspect of the disclosure, an electronic device is provided. The electronic device includes memory, and at least one processing circuit for orthogonal frequency division multiplexing (OFDM) modulation to change a domain of a symbol sequence from a first domain to a second domain. The at least one processing circuit is configured to obtain a first symbol sequence related to the first domain. The at least one processing circuit is configured to obtain a second symbol sequence by performing a cyclic shift operation on the first symbol sequence. The at least one processing circuit is configured to obtain a third symbol sequence related to the second domain by performing an inverse fast Fourier transform (IFFT) operation for a cyclic extension operation based on the second symbol sequence. The at least one processing circuit may be configured to generate a transmission signal by performing the cyclic extension operation on the third symbol sequence. For each fast Fourier transform (FFT) index of a plurality of FFT indexes according to an FFT size, the IFFT operation for the cyclic extension operation includes an operation to change a value of each of at least one bit of a bit sequence of a corresponding FFT index from 0 to 1 or 1 to 0.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment of the disclosure;

FIG. 2A illustrates a fronthaul interface according to an embodiment of the disclosure;

FIG. 2B illustrates a fronthaul interface of an open (O)-radio access network (RAN) according to an embodiment of the disclosure;

FIG. 3A illustrates a functional configuration of a distributed unit (DU) according to an embodiment of the disclosure;

FIG. 3B illustrates a functional configuration of a radio unit (RU) according to an embodiment of the disclosure;

FIG. 4 illustrates an example of a function split between a DU and an RU according to an embodiment of the disclosure;

FIG. 5 illustrates an example of an operation of an orthogonal frequency division multiplexing (OFDM) modulation circuit according to an embodiment of the disclosure;

FIG. 6 illustrates an example of a cyclic shift operation according to an embodiment of the disclosure;

FIG. 7 illustrates an example of a cyclic extension operation according to an embodiment of the disclosure;

FIG. 8 illustrates a signal flow graph related to an FFT operation of a decimation in frequency fast Fourier transform (DIF FFT) structure according to an embodiment of the disclosure;

FIG. 9 illustrates a signal flow graph related to an FFT operation using a cyclic shift operation of a DIF FFT structure according to an embodiment of the disclosure;

FIG. 10 illustrates an OFDM modulation circuit for performing an IFFT operation using a cyclic shift operation according to an embodiment of the disclosure;

FIG. 11 illustrates a signal flow graph related to an FFT operation of a decimation in time fast Fourier transform (DIT FFT) structure according to an embodiment of the disclosure;

FIG. 12 illustrates a signal flow graph related to an FFT operation for a cyclic extension operation of a DIT FFT structure according to an embodiment of the disclosure;

FIG. 13 illustrates an OFDM modulation circuit for performing an IFFT operation for a cyclic extension operation according to an embodiment of the disclosure;

FIG. 14 illustrates an example of an input and an output for a second buffer according to an embodiment of the disclosure;

FIG. 15 illustrates a flowchart related to an operation of an electronic device according to a DIF FFT structure according to an embodiment of the disclosure;

FIG. 16 is a flowchart illustrating an operation of an electronic device according to a DIT FFT structure according to an embodiment of the disclosure; and

FIG. 17 illustrates an example of a configuration of a processing device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various embodiments of the disclosure described below, a hardware approach will be described as an example. However, since the various embodiments of the disclosure include technology that uses both hardware and software, the various embodiments of the disclosure do not exclude a software-based approach.

A term referring to a signal (e.g., signal, information, message, signaling), a term referring to a resource (e.g., symbol, slot, subframe, radio frame, subcarrier, resource element (RE), resource block (RB), bandwidth part, occasion), a term for a calculation status (e.g., step, operation, procedure), a term referring to data (e.g., packet, user stream, information, bit, symbol, codeword), a term referring to a channel, a term referring to a network entity, a term referring to a component of a device, and the like, used in the following descriptions, are exemplified for convenience of explanation. Therefore, the disclosure is not limited to terms to be described below, and another term having an equivalent technical meaning may be used.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {‘C’, ‘D’, and ‘C’ and ‘D’}.

Although the disclosure describes various embodiments using terms used in some communication standards (e.g., 3rd Generation Partnership Project (3GPP), extensible radio access network (xRAN), open-radio access network (O-RAN)), these are only examples for explanation. The various embodiments of the disclosure may be easily modified and applied to other communication systems.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

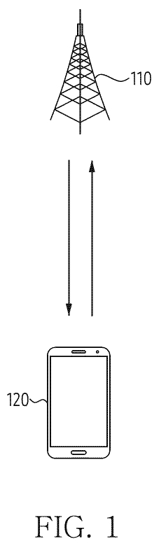

FIG. 1 illustrates a wireless communication system according to an embodiment of the disclosure.

Referring to FIG. 1, FIG. 1 illustrates a base station 110 and a terminal 120 as a portion of nodes that utilize a wireless channel in a wireless communication system. FIG. 1 illustrates only one base station, but a wireless communication system may further include another base station that is identical or similar to the base station 110.

The base station 110 is a network infrastructure that provides wireless access to the terminal 120. The base station 110 has coverage defined based on a distance at which a signal may be transmitted. In addition to ‘base station’, the base station 110 may be referred to as an ‘access point (AP)’, ‘eNodeB (eNB)’, ‘5th generation node’, ‘next generation nodeB (gNB)’, ‘wireless point’, ‘transmission/reception point (TRP)’ or other terms having equivalent technical meanings.

The terminal 120, which is a device used by a user, performs communication with the base station 110 through a wireless channel. A link from the base station 110 to the terminal 120 is referred to as a downlink (DL), and a link from the terminal 120 to the base station 110 is referred to as an uplink (UL). In addition, although not illustrated in FIG. 1, the terminal 120 and another terminal may perform communication with each other through a wireless channel. At this time, a link (device-to-device link (D2D)) between the terminal 120 and the other terminal is referred to as a sidelink, and the sidelink may be used interchangeably with a PC5 interface. In some other embodiments, the terminal 120 may be operated without the user's involvement. According to an embodiment, the terminal 120, which is a device performing machine type communication (MTC), may not be carried by the user. Additionally, according to an embodiment, the terminal 120 may be a narrowband (NB)-internet of things (IoT) device.

In addition to ‘terminal’, the terminal 120 may also be referred to as ‘user equipment (UE)’, ‘customer premises equipment, (CPE)’, ‘mobile station’, ‘subscriber station’, ‘remote terminal’, ‘wireless terminal’, ‘electronic device’, ‘user device’, or other terms having equivalent technical meanings.

The base station 110 may perform beamforming with the terminal 120. The base station 110 and the terminal 120 may transmit and receive a wireless signal in a relatively low frequency band (e.g., frequency range 1 (FR 1) of NR). In addition, the base station 110 and the terminal 120 may transmit and receive a wireless signal in a relatively high frequency band (e.g., FR 2 (or FR 2-1, FR 2-2, FR 2-3) or FR 3), and a millimeter wave (mmWave) band (e.g., 28 GHz, 30 GHz, 38 GHz, 60 GHz). The base station 110 and the terminal 120 may perform beamforming to improve a channel gain. Herein, the beamforming may include transmission beamforming and reception beamforming. The base station 110 and the terminal 120 may provide directivity to a transmission signal or a reception signal. To this end, the base station 110 and the terminal 120 may select serving beams through a beam search or beam management procedure. After the serving beams are selected, subsequent communication may be performed through a resource in a quasi-co-located (QCL) relationship with the resource transmitting the serving beams.

If large-scale characteristics of a channel carrying a symbol on a first antenna port may be inferred from a channel carrying a symbol on a second antenna port, the first antenna port and the second antenna port may be evaluated to be in the QCL relationship. For example, large-scale characteristics may include at least one of a delay spread, a Doppler spread, a Doppler shift, an average gain, an average delay, and a spatial receiver parameter.

Although FIG. 1 describes that both the base station 110 and the terminal 120 perform beamforming, the embodiments of the disclosure are not necessarily limited thereto. In some embodiments, the terminal may or may not perform beamforming. In addition, the base station may or may not perform beamforming. That is, either only one of the base station and the terminal may perform beamforming, or neither the base station nor the terminal may perform beamforming.

In the disclosure, a beam refers to a spatial flow of a signal in a wireless channel, and is formed by one or more antennas (or antenna elements), and this formation process may be referred to as beamforming. Beamforming may include at least one of analog beamforming or digital beamforming (e.g., precoding). A reference signal transmitted based on beamforming may include, for example, a demodulation-reference signal (DM-RS), a channel state information-reference signal (CSI-RS), a synchronization signal/physical broadcast channel (SS/PBCH), and a sounding reference signal (SRS). In addition, an IE such as CSI-RS resource or SRS-resource may be used as a configuration for each reference signal, and this configuration may include information associated with the beam. The information associated with the beam may mean whether a corresponding configuration (e.g., CSI-RS resource) uses the same spatial domain filter as another configuration (e.g., another CSI-RS resource within the same CSI-RS resource set) or a different spatial domain filter, or which reference signal it is quasi-co-located (QCL) with, and if so, what type it is (e.g., QCL type A, B, C, D).

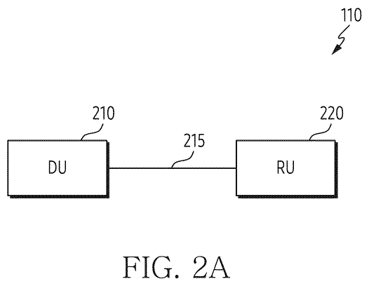

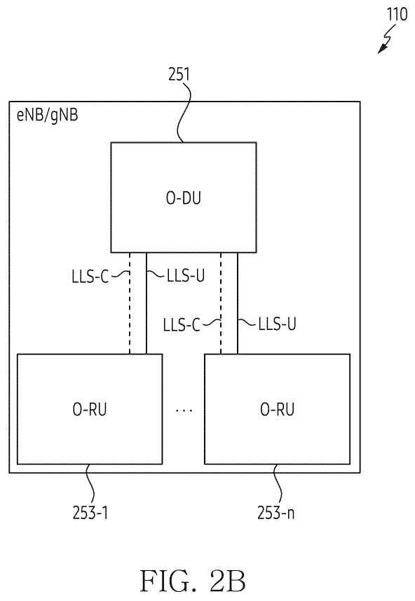

Conventionally, in a communication system with a relatively large cell radius of base station, each base station was installed to include a function of a digital processing unit (or distributed unit (DU)) and a radio frequency (RF) processing unit (or radio unit (RU)). However, as high frequency bands are used in 4th generation (4G) and/or subsequent communication systems (e.g., 5th generation (5G)) and the cell coverage of base stations is decreased, the number of base stations to cover a specific area has increased. The burden of installation cost for operators to install base stations has also increased. In order to minimize the installation cost of a base station, a structure in which the DU and RU of the base station are separated, one or more RUs are connected to one DU through a wired network, and one or more Rus geographically distributed to cover a specific area are deployed, has been proposed. Hereinafter, a deployment structure and expansion examples of a base station according to various embodiments of the disclosure are described through FIGS. 2A and 2B.

FIG. 2A illustrates a fronthaul interface according to an embodiment of the disclosure. Unlike a backhaul between a base station and a core network, the fronthaul refers to a link between entities between a WLAN and a base station. FIG. 2A illustrates an example of a fronthaul structure between one DU 210 and one RU 220, but this is only for convenience of explanation and the disclosure is not limited thereto. In other words, the embodiments of the disclosure may also be applied to a fronthaul structure between one DU and a plurality of RU. For example, the embodiments of the disclosure may be applied to a fronthaul structure between one DU and two RU. In addition, the embodiments of the disclosure may also be applied to a fronthaul structure between one DU and three RU.

Referring to FIG. 2A, the base station 110 may include a DU 210 and an RU 220. A fronthaul 215 between the DU 210 and the RU 220 may be operated via an Fx interface. For operation of the fronthaul 215, an interface such as an enhanced common public radio interface (eCPRI) or radio over ethernet (ROE) may be used.

As communication technology has been developed, mobile data traffic increased, and thus the bandwidth demand required in a fronthaul between a digital unit and a radio unit has increased significantly. In a deployment such as centralized/cloud radio access network (C-RAN), the DU may be implemented to perform functions for packet data convergence protocol (PDCP), radio link control (RLC), media access control (MAC), and physical (PHY), and the RU may be implemented to further perform functions for PHY layer in addition to a radio frequency (RF) function.

The DU 210 may be in charge of upper layer functions of a wireless network. For example, the DU 210 may perform functions of the MAC layer and a part of the PHY layer. Herein, a part of the PHY layer is a function performed at a higher level among the functions of the PHY layer, and may include, for example, channel encoding (or channel decoding), scrambling (or descrambling), modulation (or demodulation), and layer mapping (or layer demapping). According to an embodiment, if the DU 210 complies with an open radio access network (O-RAN) standard, it may be referred to as an O-RAN DU (O-DU). The DU 210 may be replaced with and represented as a first network entity for a base station (e.g., gNB) in embodiments of the disclosure, as needed.

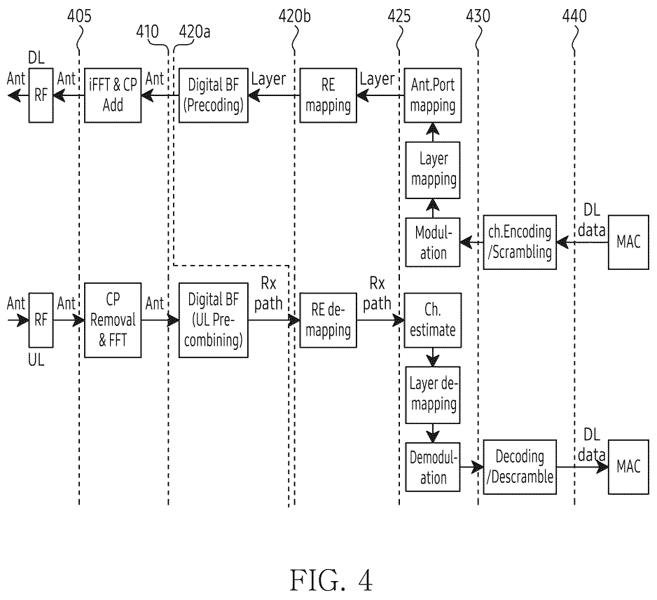

The RU 220 may be in charge of lower layer functions of a wireless network. For example, the RU 220 may perform a part of the PHY layer, and a RF function. Herein, a part of the PHY layer is a function performed at performed at a relatively lower level than the DU 210 among the functions of the PHY layer, and may include, for example, iFFT conversion (or FFT conversion), cyclic prefix (CP) insertion (or CP removal), and digital beamforming. In FIG. 4, an example of such a specific function split is described in detail. The RU 220 may be referred to as access unit (AU), access point (AP), transmission/reception point (TRP), remote radio head (RRH), radio unit (RU), or other terms having equivalent technical meanings. According to an embodiment, if the RU 220 complies with the O-RAN standard, it may be referred to as an O-RAN RU (O-RU). The RU 220 may be replaced with and represented as a second network entity for a base station (e.g., gNB) in embodiments of the disclosure, as needed.

Although FIG. 2A describes that the base station 110 includes the DU 210 and the RU 220, the embodiments of the disclosure are not limited thereto. The base station according to the embodiments may be implemented in a distributed deployment according to a centralized unit (CU) configured to perform functions of upper layers (e.g., packet data convergence protocol (PDCP), radio resource control (RRC)) of an access network and a distributed unit (DU) configured to perform functions of lower layers. At this time, the distributed unit (DU) may include the digital unit (DU) and the radio unit (RU) of FIG. 1. Between a core (e.g., 5G core (5GC) or next generation core (NGC)) network and a radio access network (RAN), the base station may be implemented in a structure in which CU, DU, and RU are arranged in order. An interface between the CU and the distributed unit (DU) may be referred to as an F1 interface.

A centralized unit (CU) may be in charge of functions of a higher layer than the DU, by being connected to one or more DUs. For example, the CU may be in charge of radio resource control (RRC) and a function of a packet data convergence protocol (PDCP) layer, and the DU and the RU may be in charge of functions of lower layers. The DU may perform radio link control (RLC), media access control (MAC), and some functions (high PHY) of PHY layer, and the RU may perform remaining functions (low PHY) of the PHY layer. In addition, as an example, a digital unit (DU) may be included in a distributed unit (DU) according to the implementation of distributed deployment of the base station. Hereinafter, unless otherwise defined, it is described as operations of the digital unit (DU) and the RU, but various embodiments of the disclosure may be applied to both of a base station arrangement including the CU or an arrangement where the DU is directly connected to a core network (i.e., the CU and the DU are integrated into a base station (e.g., NG-RAN node) which is a single entity).

FIG. 2B illustrates a fronthaul interface of an open (O)-radio access network (RAN) according to an embodiment of the disclosure. As a base station 110 according to distributed deployment, eNB or gNB is exemplified.

Referring to FIG. 2B, the base station 110 may include an O-DU 251 and O-RUs 253-1, . . . , and 253-n. Hereinafter, for convenience of explanation, an operation and a function of the O-RU 253-1 may be understood as a description of each of other O-RUs (e.g., O-RU 253-n).

The O-DU 251 is a logical node including functions among functions of a base station (e.g., eNB, gNB) according to FIG. 4 to be described later, except for functions allocated exclusively to the O-RU 253-1. The O-DU 251 may control operations of the O-RUs 253-1, . . . , and 253-n. The O-DU 251 may be referred to as a lower layer split (LLS) central unit (CU). The O-RU 253-1 is a logical node including a subset among the functions of a base station (e.g., eNB, gNB) according to FIG. 4 to be described later. The real-time aspect of the control plane (C-plane) communication and user plane (U-plane) communication with the O-RU 253-1 may be controlled by the O-DU 251.

The O-DU 251 may perform communication with the O-RU 253-1 through an LLS interface. The LLS interface corresponds to a fronthaul interface. The LLS interface refers to a logical interface between the O-DU 251 and the O-RU 253-1 using lower layer functional split (i.e., intra-physical (PHY)-based functional split). The LLS-C between the O-DU 251 and the O-RU 253-1 provides a C-plane through the LLS interface. The LLS-U between the O-DU 251 and the O-RU 253-1 provides a U-plane through the LLS interface.

In FIG. 2B, entities of the base station 110 have been described as O-DU and O-RU to describe O-RAN. However, these designations are not to be construed as limiting the embodiments of the disclosure. In embodiments described later, operations of the DU 210 may also be performed by the O-DU 251. A description of the DU 210 may be applied to the O-DU 251. Likewise, in embodiments described later, operations of the RU 220 may also be performed by the O-RU 253-1. A description of the RU 220 may be applied to the O-RU 253-1.

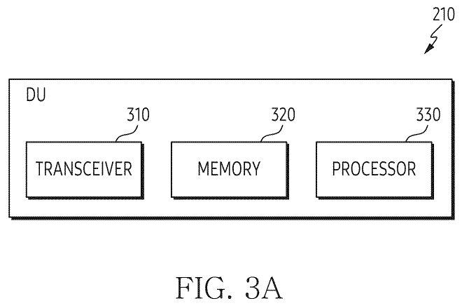

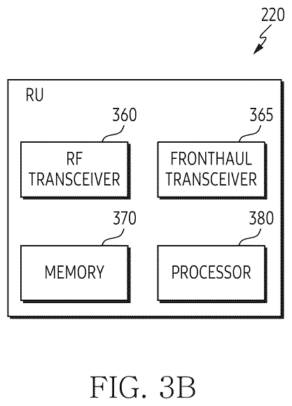

FIG. 3A illustrates a functional configuration of a distributed unit (DU) according to an embodiment of the disclosure. A configuration exemplified in FIG. 3A, which is as a part of a base station, may be understood as a configuration of the DU 210 of FIG. 2A (or the O-DU 251 of FIG. 2B). Hereinafter, the terms ‘ . . . unit’ and ‘ . . . er’ used below refer to a unit processing at least one function or operation, which may be implemented by hardware or software, or a combination of hardware and software.

Referring to FIG. 3A, a DU 210 includes a transceiver 310, memory 320, and a processor 330.

The transceiver 310 may perform functions for transmitting and receiving a signal in a wired communication environment. The transceiver 310 may include a wired interface for controlling a direct device-to-device connection through a transmission medium (e.g., copper wire, optical fiber). For example, the transceiver 310 may transmit an electrical signal to another device through a copper wire or perform conversion between an electrical signal and an optical signal. The DU 210 may communicate with a radio unit (RU) through the transceiver 310. The DU 210 may be connected to a core network or a CU of a distributed deployment through the transceiver 310.

The transceiver 310 may also perform functions for transmitting and receiving a signal in a wireless communication environment. For example, the transceiver 310 may perform a conversion function between a baseband signal and a bit string according to a physical layer specification of a system. For example, upon transmitting data, the transceiver 310 generates complex-valued symbols by encoding and modulating a transmission bit string. In addition, upon receiving data, the transceiver 310 restores a received bit string by demodulating and decoding a baseband signal. In addition, the transceiver 310 may include a plurality of transmission/reception paths. In addition, according to an embodiment, the transceiver 310 may be connected to a core network or to other nodes (e.g., integrated access backhaul (IAB)).

The transceiver 310 may transmit and receive a signal. For example, the transceiver 310 may transmit a management plane (M-plane) message. For example, the transceiver 310 may transmit a synchronization plane (S-plane) message. For example, the transceiver 310 may transmit a control plane (C-plane) message. For example, the transceiver 310 may transmit a user plane (U-plane) message. For example, the transceiver 310 may receive the U-plane message. Although only the transceiver 310 is illustrated in FIG. 3A, the DU 210 may include two or more transceivers according to another implementation.

The transceiver 310 transmits and receives a signal as described above. Accordingly, all or some of the transceiver 310 may be referred to as a ‘communication unit’, a ‘transmission unit’, a ‘reception unit’, or a ‘transmission/reception unit’. In addition, in the following description, transmission and reception performed through a wireless channel are used to the meaning including that the processing as described above is performed by the transceiver 310.

Although not illustrated in FIG. 3A, the transceiver 310 may further include a backhaul transceiver for connection with a core network or another base station. The backhaul transceiver provides an interface for performing communication with other nodes in the network. In other words, the backhaul transceiver converts a bit string transmitted from a base station to another node, such as another access node, another base station, an upper node, and a core network into a physical signal, and converts a physical signal received from another node into a bit string.

The memory 320 stores a basic program, an application program, and data such as configuration information for an operation of the DU 210. The memory 320 may be referred to as a storage unit. The memory 320 may be configured with volatile memory, nonvolatile memory, or a combination of the volatile memory and the nonvolatile memory. In addition, the memory 320 provides stored data according to a request from the processor 330.

The processor 330 controls overall operations of the DU 210. The processor 380 may be referred to as a control unit. For example, the processor 330 transmits and receives a signal through the transceiver 310 (or through a backhaul communication unit). In addition, the processor 330 writes and reads data in the memory 320. In addition, the processor 330 may perform functions of a protocol stack required in a communication standard. Although only the processor 330 is illustrated in FIG. 3A, the DU 210 may include two or more processors according to another implementation.

A configuration of the DU 210 illustrated in FIG. 3A is only an example, and an example of the DU performing the embodiments of the disclosure is not limited to the configuration illustrated in FIG. 3A. In some embodiment, some configurations may be added, deleted, or changed.

FIG. 3B illustrates a functional configuration of a radio unit (RU) according to an embodiment of the disclosure. A configuration exemplified in FIG. 3B, which is as a part of a base station, may be understood as a configuration of the RU 220 of FIG. 2B or the O-RU 253-1 of FIG. 2B. Hereinafter, the terms ‘ . . . unit’ and ‘ . . . er’ used below refer to a unit processing at least one function or operation, which may be implemented by hardware or software, or a combination of hardware and software.

Referring to FIG. 3B, the RU 220 includes an RF transceiver 360, a fronthaul transceiver 365, memory 370, and a processor 380.

The RF transceiver 360 performs functions for transmitting and receiving a signal through a wireless channel. For example, the RF transceiver 360 up-converts a baseband signal into an RF band signal and then transmits it through an antenna, and down-converts an RF band signal received through the antenna into a baseband signal. For example, the RF transceiver 360 may include a transmission filter, a reception filter, an amplifier, a mixer, an oscillator, a DAC, an ADC.

The RF transceiver 360 may include a plurality of transmission/reception paths. Furthermore, the RF transceiver 360 may include an antenna unit. The RF transceiver 360 may include at least one antenna array composed of a plurality of antenna elements. In terms of hardware, the RF transceiver 360 may be composed of a digital circuit and an analog circuit (e.g., a radio frequency integrated circuit (RFIC)). Herein, the digital circuit and the analog circuit may be implemented as a single package. In addition, the RF transceiver 360 may include a plurality of RF chains. The RF transceiver 360 may perform beamforming. In order to provide directivity to a signal to be transmitted and received according to the setting of the processor 380, the RF transceiver 360 may apply beamforming weights to the signal. According to an embodiment, the RF transceiver 360 may include a radio frequency (RF) block (or RF unit).

According to an embodiment, the RF transceiver 360 may transmit and receive a signal on a radio access network. For example, the RF transceiver 360 may transmit a downlink signal. The downlink signal may include a synchronization signal (SS), a reference signal (RS) (e.g., cell-specific reference signal (CRS), demodulation (DM)-RS), system information (e.g., MIB, SIB, remaining system information (RMSI), other system information (OSI)), configuration message, control information or downlink data. In addition, for example, the RF transceiver 360 may receive an uplink signal. The uplink signal may include a random access-related signal (e.g., random access preamble (RAP)) (or message 1 (Msg1), message 3 (Msg3)), a reference signal (e.g., sounding reference signal (SRS), DM-RS), or a power headroom report (PHR). Although only the RF transceiver 360 is illustrated in FIG. 3B, the RU 220 may include two or more RF transceivers according to another implementation.

According to embodiments, the RF transceiver 460 may transmit an RIM-RS. The RF transceiver 460 may transmit a first type of RIM-RS (e.g., RIM-RS type 1 of 3GPP) to inform the detection of remote interference. The RF transceiver 460 may transmit a second type of RIM-RS (e.g., RIM-RS type 2 of 3GPP) to inform the presence or absence of remote interference.

The fronthaul transceiver 365 may transmit and receive a signal. According to an embodiment, the fronthaul transceiver 365 may transmit and receive a signal on a fronthaul interface. For example, the fronthaul transceiver 365 may receive a management plane (M-plane) message. For example, the fronthaul transceiver 365 may receive a synchronization plane (S-plane) message. For example, the fronthaul transceiver 365 may receive a control plane (C-plane) message. For example, the fronthaul transceiver 365 may transmit a user plane (U-plane) message. For example, the fronthaul transceiver 365 may receive a U-plane message. Although only the fronthaul transceiver 365 is illustrated in FIG. 3B, the RU 220 may include two or more fronthaul transceivers according to another implementation.

As described above, the RF transceiver 360 and the fronthaul transceiver 365 transmit and receive a signal. Accordingly, all or some of the RF transceiver 360 and the fronthaul transceiver 365 may be referred to as a ‘communication unit’, a ‘transmission unit’, a ‘reception unit’, or a ‘transmission/reception unit’. In addition, in the following description, transmission and reception performed through a wireless channel are used to the meaning including that the processing as described above is performed by the RF transceiver 360. In the following description, transmission and reception performed through a wireless channel are used to the meaning including that the processing as described above is performed by the RF transceiver 360.

The memory 370 stores a basic program, an application program, and data such as configuration information for an operation of the RU 220. The memory 370 may be referred to as a storage unit. The memory 370 may be configured with volatile memory, a nonvolatile memory, or a combination of the volatile memory and the nonvolatile memory. In addition, the memory 370 provides stored data according to a request from the processor 380. According to an embodiment, the memory 370 may include memory for a condition, a command, or a setting value related to an SRS transmission scheme.

The processor 380 controls overall operations of the RU 220. The processor 380 may be referred to as a control unit. For example, the processor 380 transmits and receives a signal through the RF transceiver 360 or the fronthaul transceiver 365. In addition, the processor 380 writes and reads data in the memory 370. In addition, the processor 380 may perform functions of a protocol stack required by a communication standard. Although only the processor 380 is illustrated in FIG. 3B, the RU 220 may include two or more processors according to another implementation. The processor 380, which is an instruction set or code stored in the memory 370, may be an instruction/code at least temporarily resided in the processor 380 or a storage space storing instruction/code, or part of circuitry constituting the processor 380. In addition, the processor 380 may include various modules for performing communication. The processor 380 may control the RU 220 to perform operations according to embodiments to be described later.

A configuration of the RU 220 illustrated in FIG. 3B is only an example, and an example of the RU performing the embodiments of the disclosure is not limited to the configuration illustrated in FIG. 3B. In some embodiment, some configurations may be added, deleted, or changed.

FIG. 4 illustrates an example of a function split between a DU and an RU according to an embodiment of the disclosure. As wireless communication technology advances (e.g., the introduction of 5th generation (5G) communication system (or new radio (NR) communication system)), the used frequency bands have increased further. As a cell radius of base stations became very small, the number of RUs required to be installed further increased. In addition, in the 5G communication system, as the amount of data transmitted has increased significantly by more than 10 times, a transmission capacity of a wired network transmitted to a fronthaul has increased significantly. Due to the above-described factors, the installation cost of a wired network in the 5G communication system may be increased significantly. Therefore, in order to reduce the transmission capacity of the wired network and reduce the installation cost of the wired network, a ‘function split’ to reduce a transmission capacity of the fronthaul by transferring some functions of the DU's modem to the RU may be used.

In order to reduce the burden on the DU, a role of the RU, which was in charge of only the existing RF function, may be extended to include some functions of a physical layer. As the RU performs functions of the higher layer, the throughput of the RU increases, which may increase a transmission bandwidth in the fronthaul while lowering the delay time requirement constraints due to response processing. On the other hand, as the RU performs the functions of the higher layer, a virtualization gain decreases and the size, weight, and cost of the RU increase. In consideration of the trade-off of the above-described advantages and disadvantages, it is required to implement an optimal function split.

Referring to FIG. 4, function splits in a physical layer below a MAC layer are illustrated. In a case of downlink (DL) transmitting signals to a terminal through a wireless network, a base station may sequentially perform channel encoding/scrambling, modulation, layer mapping, antenna mapping, RE mapping, digital beamforming (e.g., precoding), iFFT conversion/CP insertion, and RF conversion. In a case of uplink (UL) receiving signals from a terminal through the wireless network, the base station may sequentially perform RF conversion, FFT conversion/CP removal, digital beamforming (pre-combining), RE demapping, channel estimation, layer demapping, demodulation, decoding/discrambling. According to the above-described trade-off, the split of uplink functions and downlink functions may be defined in various types, by needs among vendors, discussion of standards, and the like.

In a first function split 405, the RU performs the RF function, and the DU performs the PHY function. The first function split is substantially such that the PHY function is not implemented within the RU, and as an example, it may be referred to as Option 8. In a second function split 410, the RU performs iFFT conversion/CP insertion in the DL of the PHY function and FFT conversion/CP removal in the UL, and the DU performs the remaining PHY functions. As an example, the second function split 410 may be referred to as Option 7-1. In a third function split 420a, the RU performs iFFT conversion/CP insertion in the DL of the PHY function and FFT conversion/CP removal and digital beamforming in the UL, and the DU performs the remaining PHY functions. As an example, the third function split 420a may be referred to as Option 7-2x Category A. In a fourth function split 420b, the RU performs digital beamforming in both DL and UL, and the DU performs upper PHY functions after digital beamforming. As an example, the fourth function split 420b may be referred to as Option 7-2x Category B. In a fifth function split 425, the RU performs RE mapping (or RE demapping) in both DL and UL, and the DU performs upper PHY functions after RE mapping (or RE demapping). As an example, the fifth function split 425 may be referred to as Option 7-2. In a sixth function split 430, the RU performs up to modulation (or demodulation) in both DL and UL, and the DU performs upper PHY functions after modulation (or demodulation). As an example, the sixth function split 430 may be referred to as Option 7-3. In a seventh function split 440, the RU performs up to encoding/scrambling (or decoding/discrambling) in both DL and UL, and the DU performs upper PHY functions after modulation (or demodulation). As an example, the seventh function split 440 may be referred to as option 6.

According to an embodiment, in a case that a large amount of signal processing is expected, such as in FR 1 MMU, a function split (e.g., the fourth function split 420b) in a relatively high layer may be required to reduce a fronthaul capacity. Additionally, in a function split (e.g., the sixth function split 430) at a too high layer, as a control interface becomes complex and multiple PHY processing blocks are included in the RU, which may cause a burden on the implementation of the RU, a suitable function split may be required according to the arrangement and implementation method of the DU and RU.

According to an embodiment, in a case that precoding of data received from the DU cannot be processed (i.e., in a case that there is a limit to the precoding capability of the RU), the third function split 420a or a lower function split (e.g., the second function split 410) may be applied. Conversely, in a case that there is a capability to process precoding of data received from the DU, the fourth function split 420b or a higher function split (e.g., the sixth function split 430) may be applied.

Hereinafter, unless otherwise specified, the embodiments in the disclosure are described based on the third function split 420a (it may be referred to as category A (CAT-A)), or the fourth function split 420b (it may be referred to as category B (CAT-B)) for performing beamforming processing in the RU. In the O-RAN standard, the type of O-RU is distinguished according to whether the precoding function is located at an interface of the O-DU or an interface of the O-RU. An O-RU in which precoding is not performed (i.e., low complexity) may be referred to as a CAT-A O-RU. An O-RU in which precoding is performed may be referred to as a CAT-B O-RU.

Hereinafter, an upper PHY means a physical layer processing processed in a DU of a fronthaul interface. For example, the upper-PHY may include FEC encoding/decoding, scrambling, modulation/demodulation. Hereinafter, a lower-PHY means a physical layer processing processed in an RU of the fronthaul interface. For example, the lower-PHY may include FFT/iFFT, digital beamforming, physical random access channel (PRACH) extraction, and filtering. However, the above-described criteria do not exclude embodiments through other function splits. Functional configurations, signaling, or operations of embodiments described later may be applied not only to the third function split 420a or the fourth function split 420b, but also to other function splits.

The embodiments of the disclosure exemplarily describe standards of eCPRI and O-RAN as a fronthaul interface when transmitting a message between a DU (e.g., the DU 210) of FIG. 2A) and an RU (e.g., the RU 220 of FIG. 2A). The Ethernet payload of the message may include an eCPRI header, an O-RAN header, and an additional field. Hereinafter, various embodiments of the disclosure are described using standard terms of eCPRI or O-RAN, but other expressions having equivalent meanings to each term may be used as substitutes in various embodiments of the disclosure. Hereinafter, various embodiments of the disclosure are described by using specification terminology of eCPRI or O-RAN, but the disclosure is not limited thereto. For example, in various embodiments of the disclosure, a CPRI specification may be used as a fronthaul interface.

Ethernet and eCPRI, which are easy to share with networks, may be used as a transport protocol of fronthaul. The eCPRI header and the O-RAN header may be included in the Ethernet payload. The eCPRI header may be located at the front of the Ethernet payload. The eCPRI header has the following contents.
1) ecpriVersion (4 bits): This parameter indicates an eCPRI protocol version.
2) ecpriReserved (3 bits): This parameter is reserved for further use of eCPRI.
3) ecpriConcatenation (1 bit): This parameter indicates when eCPRI concatenation is in use.
4) ecpriMessage (1 byte): This parameter indicates a type of a service carried by a message type. For example, the parameter indicates an IQ data message, a real-time control data message, or a transport network delay measurement message.
5) ecpriPayload (2 bytes): This parameter indicates a byte size of a payload portion of the eCPRI message.
6) ecpriRtcid/ecpriPcid (2 bytes): This parameter is an extended Antenna-carrier (eAxC) identifier (eAxC ID) and identifies a specific data flow related to each of C-plane (ecpriRtcid) or U-plane (ecpriPcid) message.
7) ecpriSeqid (2 bytes): This parameter provides unique message identification and order at two levels. The first octet of this parameter is a sequence ID used to identify the order of messages within an eAxC message stream, and the sequence ID is used to ensure that all messages are received and to reorder out-of-order messages. The second octet of this parameter is a subsequence ID. The subsequence ID is used to verify ordering and implement reordering when radio-transport-level (eCPRI or IEEE-1914.3) fragmentation occurs.

The eAxC identifier (ID) includes a band and sector identifier (‘BandSector_ID’), a component carrier identifier (‘CC_ID’), a spatial stream identifier (‘RU_Port_ID’), and a distributed unit identifier (‘DU_Port_ID’). The bit allocation of the eAxC ID may be distinguished as follows.
1) DU_port ID: The DU_port ID is used to distinguish processing units in the O-DU (e.g. different baseband cards). It is expected that the O-DU will allocate bits for the DU_port ID and the O-RU will attach the same value to the UL U-plane message carrying the same sectionId data.
2) BandSector_ID: Aggregated cell identifier (identification of band and sector supported by O-RU).
3) CC_ID: CC_ID identifies carrier components supported by the O-RU.
4) RU_port ID: The RU_port ID designates logical flows such as data layer or spatial streams, and logical flows such as separate numerologies (e.g., PRACH) or signal channels like SRS requiring specific antenna assignments.

An application protocol of the fronthaul may include a control plane (C-plane), a user plane (U-plane), a synchronization plane (S-plane), and a management plane (M-plane).

The control plane may be configured to provide scheduling information and beamforming information via a control message. The control plane means real-time control between the DU and the RU. The user plane may include IQ sample data transmitted between the DU and the RU. The user plane may include downlink data (IQ data or SSB/RS), uplink data (IQ data or SRS/RS), or PRACH data of the user. A weight vector of the beamforming information described above may be multiplied by the user's data. The synchronization plane generally means traffic between the DU and the RU for a synchronization controller (e.g., IEEE grand master). The synchronization plane may be related to timing and synchronization. The management plane means non-real-time control between the DU and the RU. The management plane may be related to initial setup, non-realtime reset or reset, and non-realtime report.

A message in the control plane, that is, the C-plane message, may be encapsulated based on a two-layer header approach. A first layer may be configured with eCPRI common header or the IEEE 1914.3 common header, which includes fields used to indicate a message type. A second layer is an application layer, which includes fields necessary for control and synchronization. In the application layer, a section defines a characteristic of U-plane data transmitted or received on a beam with one pattern ID. The section types supported within the C-plane are as follows.

Section Type may indicate the purpose of the control message transmitted in the control plane. For example, the purposes of Section Type are as follows.
1) sectionType=0: Used to indicate resource blocks or symbols not used in the DL or the UL.
2) sectionType=1: Used for most DL/UL wireless channels. Herein, “most” refers to channels that do not require time or frequency offsets such as those required for mixed numerology channels.
3) sectionType=2: reserved for further use
4) sectionType=3: PRACH and mixed-numerology channels. Channels that require time or frequency offsets or differ from the nominal SCS value(s).
5) sectionType=4: reserved for further use
6) sectionType=5: UE scheduling information. Transmits UE scheduling information so that the RU can perform real-time BF weight calculation (O-RAN optional BF method)
7) sectionType=6: Transmit UE-specific channel information. Periodically transmits UE channel information so that the RU can perform real-time BF weight calculation (O-RAN optional BF method)
8) sectionType=7: Used for LAA support

In the following specification, an electronic device (e.g., the base station of FIG. 1 or the RU 220 of FIGS. 2A, 2B, 3A, and 3B) may include at least one processing circuit for orthogonal frequency division multiplexing (OFDM) modulation that changes a domain of a symbol sequence from a first domain to a second domain. The at least one processing circuit may include memory (or a buffer) for the OFDM modulation. For example, the at least one processing circuit may be referred to as an OFDM modulation circuit. Hereinafter, a technical feature for optimizing memory and minimizing latency of the OFDM modulation circuit will be described.

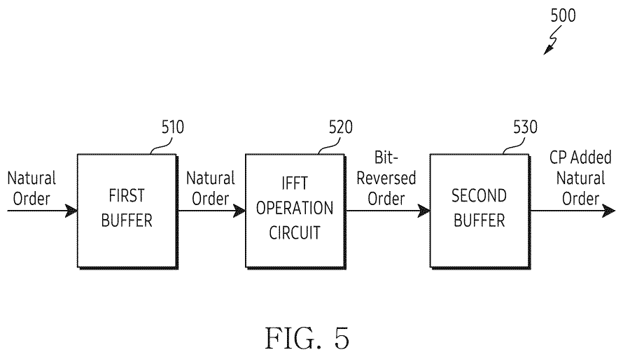

FIG. 5 illustrates an example of an operation of an orthogonal frequency division multiplexing (OFDM) modulation circuit according to an embodiment of the disclosure.

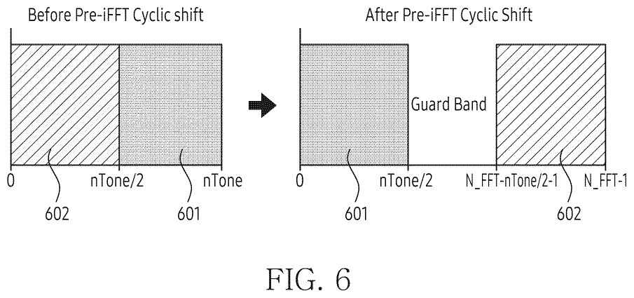

FIG. 6 illustrates an example of a cyclic shift operation according to an embodiment of the disclosure.

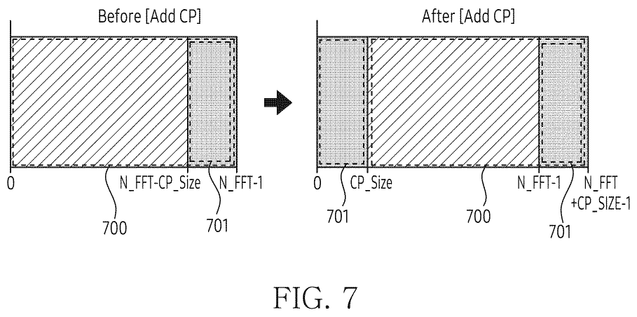

FIG. 7 illustrates an example of a cyclic extension operation according to an embodiment of the disclosure.

A new radio (NR) standard or a long term evolution (LTE) standard systems (e.g., a base station or user equipment (UE)) may include the OFDM modulation circuit.

For example, the OFDM modulation circuit may change a domain of a signal (or a symbol sequence) from a frequency domain to a time domain based on performing an FFT operation. As an example, the base station may change a domain of a downlink signal from a frequency domain to a time domain through the OFDM modulation circuit. The base station may transmit the downlink signal of the time domain to the UE. As an example, the UE may change a domain of an uplink signal from a frequency domain to a time domain through the OFDM modulation circuit. The UE may transmit the uplink signal of the time domain to the base station.

For example, the OFDM modulation circuit may change a domain of a signal (or a symbol sequence, a symbol) from a time domain to a frequency domain based on performing an IFFT operation. As an example, the base station may change a domain of an uplink signal from a time domain to a frequency domain through the OFDM modulation circuit. The base station may identify data of the uplink signal based on changing the domain of the uplink signal received from the UE from the time domain to the frequency domain. As an example, the UE may change a domain of a downlink signal from a time domain to a frequency domain through the OFDM modulation circuit. The UE may identify data of the downlink signal based on changing the domain of the downlink signal received from the base station from the time domain to the frequency domain.

Referring to FIG. 5, an OFDM modulation circuit 500 may include a first buffer 510, an inverse fast Fourier transform (IFFT) operation circuit 520, and/or a second buffer 530.

The first buffer 510 may be used for a cyclic shift operation. For example, the OFDM modulation circuit 500 may perform a cyclic shift operation on a signal (or a symbol sequence or a symbol). The cyclic shift operation may be referred to as a pre-IFFT operation or an IFFT shift operation.

Referring to FIG. 6, the signal (or the symbol sequence, the symbol) may be divided into a signal 601 of a first band (e.g., a high band) and a signal 602 of a second band (e.g., a low band) for the cyclic shift operation. For example, the number of tones related to the signal may be n. The number of tones related to the signal 601 may be n/2. The number of tones related to the signal 602 may be n/2.

The OFDM modulation circuit 500 may change an order of the signal 601 and the signal 602. The OFDM modulation circuit 500 may configure the signal 601 as a front end part of an input for the IFFT operation. The OFDM modulation circuit 500 may configure the signal 602 as a rear end part of the input for the IFFT operation. The OFDM modulation circuit 500 may configure a guard band between the signal 601 and the signal 602. The OFDM modulation circuit 500 may set input values for the IFFT operation corresponding to the guard band to 0, in order to configure the guard band. Based on the above-described process, the OFDM modulation circuit 500 may perform the cyclic shift operation. N_FFT of FIG. 6 may indicate an FFT size.

The OFDM modulation circuit 500 may use the first buffer 510 to perform the cyclic shift operation. A size of the first buffer 510 may be set to twice the maximum number (or FFT size) of tones of the signal. For example, for the first buffer 510, a dual buffer having a depth twice the maximum number (or FFT size) of the tones of the signal may be used.

Referring to FIG. 5, the IFFT operation circuit 520 may be configured as a decision in frequency (DIF) FFT structure of a Cooley-Tukey FFT algorithm for pipelined FFT. In a case that the IFFT operation circuit 520 is configured as a DIF IFFT structure (or the DIF FFT structure), a signal (or a symbol sequence, a symbol) of a bit-reversed order may be outputted based on a signal (or a symbol sequence, a symbol) of a natural bit order (or natural order) being inputted to the IFFT operation circuit 520.

As described above, in a case that the IFFT operation circuit 520 is configured as the DIF IFFT structure, since the signal (or the symbol sequence, the symbol) of the bit-reversed order is outputted, the OFDM modulation circuit 500 may perform a reordering operation (or function) to change the signal (or the symbol sequence, the symbol) back to the natural bit order. The reordering operation (or function) may be set as illustrated in Equation 1 below.

$$y = {\sum }_{n = 0}^{⌊ {log}_{2}^{( {N}_{{FFT}^{- 1}} )} ⌋} \{ {2}^{( ⌊ {log}_{2}^{( {N}_{{FFT}^{- 1}} )} ⌋ - n )} ( ⌊ \frac{x}{{2}^{n}} ⌋ mod 2 ) \} \qquad Equation 1$$

Referring to Equation 1, x is a natural order index. y is a bit-reversed order index. N_{FFT} is a size of FFT.

The second buffer 530 may be used for a cyclic extension operation. For example, the OFDM modulation circuit 500 may perform a cyclic extension operation on an output signal of the IFFT operation circuit 520. For example, the OFDM modulation circuit 500 may perform a cyclic extension operation based on inserting a cyclic prefix (CP) into a signal. The cyclic extension operation may be referred to as a CP insertion operation.

Referring to FIG. 7, the CP insertion operation may be performed by inserting a signal 701 (or data) of a designated time interval at an end of an OFDM symbol 700 in a time domain into a front of the OFDM symbol 700. In the signal on which the CP insertion operation has been performed, the signal 701 may be configured in front of the OFDM symbol 700. The signal 701 may be referred to as a cyclic prefix (CP).

Referring to FIG. 5, the reordering operation (or function) and the CP insertion operation (or function) may be performed only in a case that all sample data are stored. Since data is constantly outputted in the pipelined FFT structure, a size of the second buffer 530 may be set to twice the size of the FFT. For example, for the second buffer 530, a dual buffer having a depth twice the size of the FFT may be used.

According to an embodiment, a multi-antenna may be used in a wireless communication system for the purpose of spatial multiplexing, reducing interference between signals, improving diversity and/or reliability. As the number of antennas increases, an FFT point size may increase due to real-time multi-antenna signal processing and bandwidth expansion. As the FFT point size increases, hardware resource usage (e.g., memory usage) in the OFDM modulation circuit (or an OFDM modulation demodulation circuit) may increase.

The increase in the hardware resource usage as described above may cause an increase in latency of a system and a decrease in response speed. Capital expenditures and operating expenditures may increase due to increased power consumption. In addition, due to an increase in heat generation, a size of a product for heat dissipation may increase. Therefore, a technical feature may be required to prevent this in the OFDM modulation circuit (or an OFDM demodulation circuit). Hereinafter, the technical feature for reducing the hardware resource usage in the OFDM modulation circuit (or the OFDM demodulation circuit) will be described.

Hereinafter, a technical feature for optimizing memory in an OFDM modulation circuit of a decision in frequency (DIF) FFT structure and an OFDM modulation circuit of a decision in time (DIT) FFT structure may be described.

First, a discrete Fourier transform (DFT) operation for the FFT operation may be configured as illustrated in Equation 2.

$${W}_{N}^{nk} = {e}^{- j 2 π nk / N} \qquad Equation 2$$

Referring to Equation 2, n is a time domain index. k is a frequency domain index.

$${W}_{N}^{nk}$$

is a twiddle factor.

For example, the twiddle factor may be configured as illustrated in Equation 3.

$${W}_{N}^{nk} = {e}^{- j 2 π nk / N} \qquad Equation 3$$

Based on the above-described DFT operation, the FFT operation may be configured. For the FFT operation, with respect to N=2^{p} complex-number inputs x(n), a signal flow graph of p stages (or operations) is configured, and N/2 operations of a butterfly structure may be performed for each stage.

Hereinafter, for convenience of explanation, a 16-point FFT operation will be described below. However, this is for convenience of explanation, and the FFT size may be changed according to an embodiment.

The above-described Equation 2 may be configured as illustrated in Equation 4 when decomposed into binary stages.

$$X ( {k}_{1} + 2 {k}_{2} + 4 {k}_{3} + 8 {k}_{4} ) = {\sum }_{{n}_{4} = 0}^{1} {\sum }_{{n}_{3} = 0}^{1} {\sum }_{{n}_{2} = 0}^{1} {\sum }_{{n}_{1} = 0}^{1} x ( \frac{N}{2} {n}_{1} + \frac{N}{4} {n}_{2} + \frac{N}{8} {n}_{3} + \frac{N}{16} {n}_{4} ) {W}_{N}^{( \frac{N}{2} {n}_{1} + \frac{N}{4} {n}_{2} + \frac{N}{8} {n}_{3} + \frac{N}{16} {n}_{4} ) ( {k}_{1} + 2 {k}_{2} + 4 {k}_{3} + 8 {k}_{4} )} \qquad Equation 4$$

Based on the FFT operation configured as illustrated in Equation 4, the OFDM modulation circuit of the DIF IFFT structure (or the DIF FFT structure) and the OFDM modulation circuit of the DIT IFFT structure (or DIT FFT structure) may be configured.

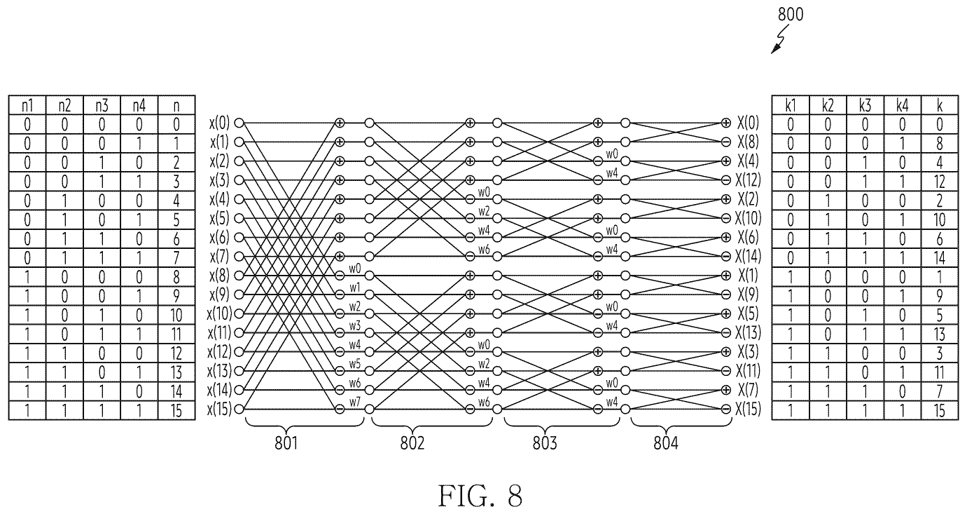

In FIGS. 8 to 10, an example in which a cyclic shift operation is performed according to an IFFT operation in the OFDM modulation circuit of the DIF IFFT structure will be described.

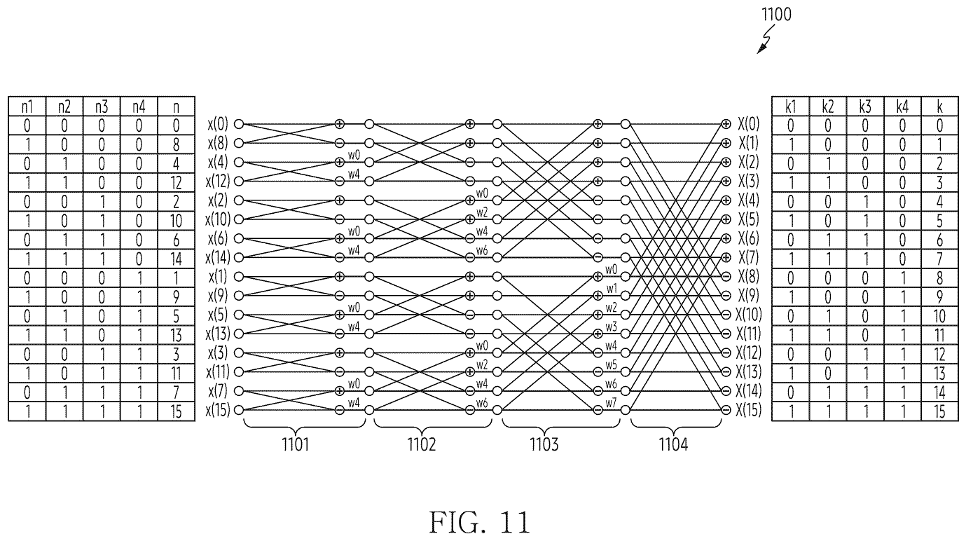

In FIGS. 11 to 14, an example in which a cyclic extension operation is performed according to an IFFT operation in the OFDM modulation circuit of the DIT IFFT structure will be described.

FIG. 8 illustrates a signal flow graph related to an FFT operation of a decimation in frequency fast Fourier transform (DIF FFT) structure according to an embodiment of the disclosure.

Referring to FIG. 8, Equation 4 may be developed as Equation 5. According to development for

$${n}_{1} ( , {\sum }_{{n}_{1} = 0}^{1} )$$

in Equation 4, the FFT operation may be configured as illustrated in Equation 5.

$$X ( {k}_{1} + 2 {k}_{2} + 4 {k}_{3} + 8 {k}_{4} ) = {\sum }_{{n}_{4} = 0}^{1} {\sum }_{{n}_{3} = 0}^{1} {\sum }_{{n}_{2} = 0}^{1} [ \text{} x ( \text{} \frac{N}{4} {n}_{2} + \frac{N}{8} {n}_{3} + \frac{N}{16} {n}_{4} ) \text{} {W}_{N}^{( \frac{N}{4} {n}_{2} + \frac{N}{8} {n}_{3} + \frac{N}{16} {n}_{4} ) ( {k}_{1} + 2 {k}_{2} + 4 {k}_{3} + 8 {k}_{4} )} + x ( \text{} \frac{N}{2} + \frac{N}{4} {n}_{2} + \frac{N}{8} {n}_{3} + \frac{N}{16} {n}_{4} ) {W}_{N}^{( \frac{N}{2} + \frac{N}{4} {n}_{2} + \frac{N}{8} {n}_{3} + \frac{N}{16} {n}_{4} ) ( {k}_{1} + 2 {k}_{2} + 4 {k}_{3} + 8 {k}_{4} )} ] \qquad Equation 5$$

In Equation 5, according to development for n2, n3, and n4, the FFT operation may be configured as illustrated in Equation 6.

$$X ( {k}_{1} + 2 {k}_{2} + 4 {k}_{3} + 8 {k}_{4} ) = \begin{matrix}[ \begin{matrix}[ \begin{matrix}\{ x ( 0 ) + ( - 1 ) \text{?} x ( \frac{8 N}{16} ) \} {\text{?}}^{( \frac{N}{4} {n}_{2} + \frac{N}{8} {n}_{3} + \frac{N}{16} {n}_{4} )} \\ + {( - 1 )}^{{k}_{2}} \{ x ( \frac{4 N}{16} ) + ( - 1 ) \text{?} x ( \frac{12 N}{16} ) \} {\text{?}}^{( \frac{N}{4} {n}_{2} + \frac{N}{8} {n}_{3} + \frac{N}{16} {n}_{4} )}\end{matrix} ] {W}_{N}^{2 {k}_{2} ( \frac{N}{8} {n}_{3} + \frac{N}{16} {n}_{4} )} \\ + {( - )}^{{k}_{2}} [ \begin{matrix}\{ x ( \frac{2 N}{16} ) + ( - 1 ) \text{?} x ( \frac{10 N}{16} ) \} {\text{?}}^{( \frac{N}{4} {n}_{2} + \frac{N}{8} {n}_{3} + \frac{N}{16} {n}_{4} )} \\ + {( - 1 )}^{{k}_{2}} \{ x ( \frac{6 N}{16} ) + ( - 1 ) \text{?} x ( \frac{14 N}{16} ) \} {\text{?}}^{( \frac{N}{4} {n}_{2} + \frac{N}{8} {n}_{3} + \frac{N}{16} {n}_{4} )}\end{matrix} ] {W}_{N}^{2 {k}_{2} ( \frac{N}{8} {n}_{3} + \frac{N}{16} {n}_{4} )}\end{matrix} ] {W}_{N}^{4 {k}_{3} ( \frac{N}{16} {n}_{4} )} \\ + {( - 1 )}^{{k}_{4}} [ \begin{matrix}[ \begin{matrix}\{ x ( \frac{N}{16} ) + ( - 1 ) \text{?} x ( \frac{9 N}{16} ) \} {\text{?}}^{( \frac{N}{4} {n}_{2} + \frac{N}{8} {n}_{3} + \frac{N}{16} {n}_{4} )} \\ + {( - 1 )}^{{k}_{2}} \{ x ( \frac{5 N}{16} ) + ( - 1 ) \text{?} x ( \frac{13 N}{16} ) \} {\text{?}}^{( \frac{N}{4} {n}_{2} + \frac{N}{8} {n}_{3} + \frac{N}{16} {n}_{4} )}\end{matrix} ] {W}_{N}^{2 {k}_{2} ( \frac{N}{8} {n}_{3} + \frac{N}{16} {n}_{4} )} \\ + {( - )}^{{k}_{2}} [ \begin{matrix}\{ x ( \frac{3 N}{16} ) + ( - 1 ) \text{?} x ( \frac{11 N}{16} ) \} {\text{?}}^{( \frac{N}{4} {n}_{2} + \frac{N}{8} {n}_{3} + \frac{N}{16} {n}_{4} )} \\ + {( - 1 )}^{{k}_{2}} \{ x ( \frac{7 N}{16} ) + ( - 1 ) \text{?} x ( \frac{15 N}{16} ) \} {\text{?}}^{( \frac{N}{4} {n}_{2} + \frac{N}{8} {n}_{3} + \frac{N}{16} {n}_{4} )}\end{matrix} ] {W}_{N}^{2 {k}_{2} ( \frac{N}{8} {n}_{3} + \frac{N}{16} {n}_{4} )}\end{matrix} ] {W}_{N}^{4 {k}_{3} ( \frac{N}{16} {n}_{4} )}\end{matrix} \qquad Equation 6$$

$$\text{?} \text{indicates text missing or illegible when filed}$$

A signal flow graph 800 may be configured according to Equation 6. The signal flow graph 800 illustrates the FFT operation, but a signal flow graph according to an IFFT operation, which is an inverse operation of the FFT operation, may be configured similar to the signal flow graph 800. For convenience of explanation, the signal flow graph according to the IFFT operation may be described as the signal flow graph 800.

For example, referring to the signal flow graph 800, as an IFFT operation on a symbol sequence (or a symbol) set based on a natural bit order is performed, a symbol sequence (or a symbol) set based on a bit-reversed order may be outputted (or obtained). Thus, in order to align the symbol sequence set based on the bit-reversed order (or align an FFT index (time domain index)), all data on the symbol sequence may be stored in memory (e.g., the second buffer 530 of FIG. 5) and then outputted.

According to an embodiment, the signal flow graph 800 may include a plurality of stages. For example, the signal flow graph 800 may include a stage 801, a stage 802, a stage 803, and a stage 804. An OFDM modulation circuit may perform the operation of Equation 6 by sequentially performing operations related to the stage 801 to the stage 804.

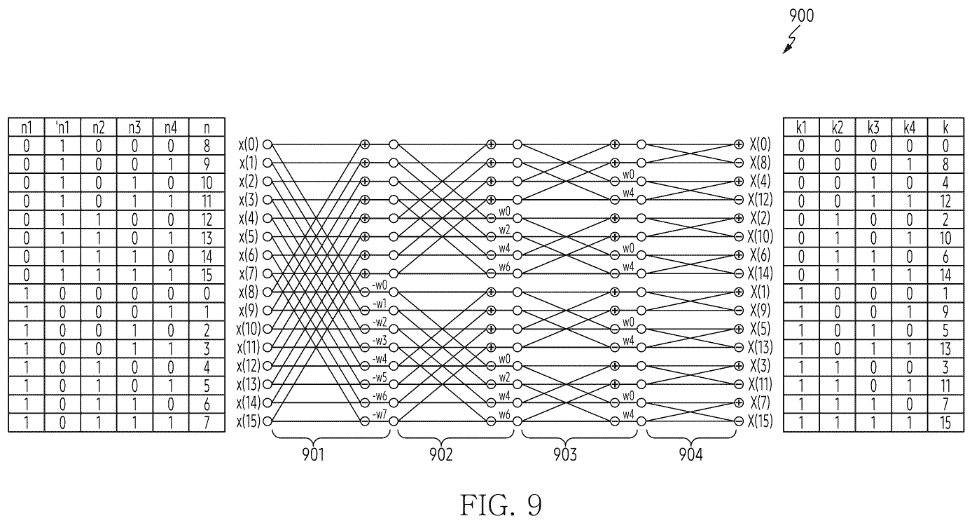

FIG. 9 illustrates a signal flow graph related to an FFT operation using a cyclic shift operation of a DIF FFT structure according to an embodiment of the disclosure.

Referring to FIG. 9, in order to configure an IFFT operation circuit using the cyclic shift operation, n₁ may be substituted with ‘n₁ in Equation 4 described above. For example, n1 may be an MSB of a bit sequence of an FFT index (frequency domain index). For example, ‘n₁ may be configured as illustrated in Equation 7.

$$‘ {n}_{1} = ( {n}_{1} + 1 ) mod 2 \qquad Equation 7$$

Referring to Equation 7, ‘n₁ is a value at which a modulo 2 operation is performed on n₁+1.

In Equation 4, as n₁ is substituted with ‘n₁ according to Equation 7, the FFT operation of the DIF FFT structure may be configured as illustrated in Equation 8.

$$X ( {k}_{1} + 2 {k}_{2} + 4 {k}_{3} + 8 {k}_{4} ) = \begin{matrix}[ \begin{matrix}[ \begin{matrix}\{ x ( 0 ) + ( - 1 ) \text{?} x ( \frac{8 N}{16} ) \} {\text{?}}^{( \frac{N}{4} {n}_{2} + \frac{N}{8} {n}_{3} + \frac{N}{16} {n}_{4} )} \\ + {( - 1 )}^{{k}_{2}} \{ x ( \frac{4 N}{16} ) + ( - 1 ) \text{?} x ( \frac{12 N}{16} ) \} {\text{?}}^{( \frac{N}{4} {n}_{2} + \frac{N}{8} {n}_{3} + \frac{N}{16} {n}_{4} )}\end{matrix} ] {W}_{N}^{2 {k}_{2} ( \frac{N}{8} {n}_{3} + \frac{N}{16} {n}_{4} )} \\ + {( - )}^{{k}_{2}} [ \begin{matrix}\{ x ( \frac{2 N}{16} ) + ( - 1 ) \text{?} x ( \frac{10 N}{16} ) \} {\text{?}}^{( \frac{N}{4} {n}_{2} + \frac{N}{8} {n}_{3} + \frac{N}{16} {n}_{4} )} \\ + {( - 1 )}^{{k}_{2}} \{ x ( \frac{6 N}{16} ) + ( - 1 ) \text{?} x ( \frac{14 N}{16} ) \} {\text{?}}^{( \frac{N}{4} {n}_{2} + \frac{N}{8} {n}_{3} + \frac{N}{16} {n}_{4} )}\end{matrix} ] {W}_{N}^{2 {k}_{2} ( \frac{N}{8} {n}_{3} + \frac{N}{16} {n}_{4} )}\end{matrix} ] {W}_{N}^{4 {k}_{3} ( \frac{N}{16} {n}_{4} )} \\ + {( - 1 )}^{{k}_{4}} [ \begin{matrix}[ \begin{matrix}\{ x ( \frac{N}{16} ) + ( - 1 ) \text{?} x ( \frac{9 N}{16} ) \} {\text{?}}^{( \frac{N}{4} {n}_{2} + \frac{N}{8} {n}_{3} + \frac{N}{16} {n}_{4} )} \\ + {( - 1 )}^{{k}_{2}} \{ x ( \frac{5 N}{16} ) + ( - 1 ) \text{?} x ( \frac{13 N}{16} ) \} {\text{?}}^{( \frac{N}{4} {n}_{2} + \frac{N}{8} {n}_{3} + \frac{N}{16} {n}_{4} )}\end{matrix} ] {W}_{N}^{2 {k}_{2} ( \frac{N}{8} {n}_{3} + \frac{N}{16} {n}_{4} )} \\ + {( - )}^{{k}_{2}} [ \begin{matrix}\{ x ( \frac{3 N}{16} ) + ( - 1 ) \text{?} x ( \frac{11 N}{16} ) \} {\text{?}}^{( \frac{N}{4} {n}_{2} + \frac{N}{8} {n}_{3} + \frac{N}{16} {n}_{4} )} \\ + {( - 1 )}^{{k}_{2}} \{ x ( \frac{7 N}{16} ) + ( - 1 ) \text{?} x ( \frac{15 N}{16} ) \} {\text{?}}^{( \frac{N}{4} {n}_{2} + \frac{N}{8} {n}_{3} + \frac{N}{16} {n}_{4} )}\end{matrix} ] {W}_{N}^{2 {k}_{2} ( \frac{N}{8} {n}_{3} + \frac{N}{16} {n}_{4} )}\end{matrix} ] {W}_{N}^{4 {k}_{3} ( \frac{N}{16} {n}_{4} )}\end{matrix} \qquad Equation 8$$

$$\text{?} \text{indicates text missing or illegible when filed}$$

As a cyclic shift is performed by half an FFT size, the FFT operation of the DIF FFT structure may be configured as illustrated in Equation 8 described above.

When Equation 6 and Equation 8 are compared, when a sign of a twiddle factor of a first stage in Equation 6 is changed to a negative number, the same Equation as Equation 8 may be identified.

A signal flow graph 900 may be configured according to Equation 8. The signal flow graph 900 illustrates an FFT operation, but a signal flow graph according to an IFFT operation, which is an inverse operation of the FFT operation, may be configured similar to the signal flow graph 900. For convenience of explanation, the signal flow graph according to the IFFT operation may be described as the signal flow graph 900.

As signs of twiddle factors are converted to a negative number in a stage 801, which is a first stage in the signal flow graph 800 of FIG. 8, the signal flow graph 900 may be configured. Complexity of an IFFT operation circuit configured according to Equation 8 may be the same as or similar to complexity of an IFFT operation circuit configured according to Equation 6.

According to an embodiment, the signal flow graph 900 may include a plurality of stages. For example, the signal flow graph 900 may include a stage 901, a stage 902, a stage 903, and a stage 904. An OFDM modulation circuit may perform the operation of Equation 6 by sequentially performing operations related to the stage 901 to the stage 904. The stage 901 may be configured by converting signs of the twiddle factors of the stage 801 of FIG. 8 to a negative number.

According to Equation 8 (or the signal flow graph 900), a cyclic shift operation may be performed by half the FFT size according to a structural change (or a change in the operation).

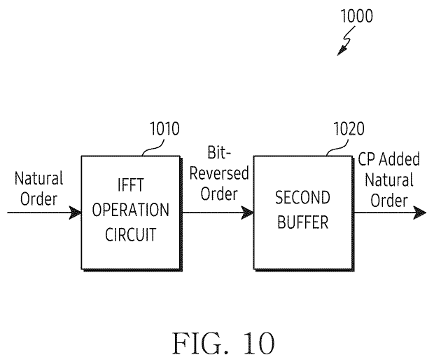

FIG. 10 illustrates an OFDM modulation circuit for performing an IFFT operation using a cyclic shift operation according to an embodiment of the disclosure.

Referring to FIG. 10, an OFDM modulation circuit 1000 may include an IFFT operation circuit 1010 and a second buffer 1020. For example, the IFFT operation circuit 1010 may be configured based on the signal flow graph 900 of FIG. 9 (or Equation 8 described above). The second buffer 1020 may correspond to the second buffer 530 of FIG. 5.

Since an output in which a cyclic shift operation is performed by half an FFT size may be obtained through the IFFT operation circuit 1010, a separate buffer (e.g., the first buffer 510 of FIG. 5) for the cyclic shift operation may not be used. Therefore, compared to the OFDM modulation circuit 500 of FIG. 5, since an additional buffer for the cyclic shift operation in the OFDM modulation circuit 1000 is not required, hardware resource usage may be reduced. In addition, in a case that the OFDM modulation circuit 1000 is configured, processing speed of a signal (or a symbol sequence, a symbol) may be increased.

In the above-described embodiments (e.g., the embodiments of FIGS. 8 to 10), an example in which an FFT size is set to 16 has been described, but this is for convenience of explanation, and the FFT size may be variously set. In addition, the above-described embodiments have been described based on a Radix 2 algorithm, but this is for convenience of explanation. A technical feature according to the above-described embodiments may be applied to various algorithms including a Radix 4 algorithm and a Radix 2\hat{ }2 algorithm.

FIG. 11 illustrates a signal flow graph related to an FFT operation of a decimation in time fast Fourier transform (DIT FFT) structure according to an embodiment of the disclosure.

Referring to FIG. 11, Equation 4 described above may be developed as Equation 5 described above. In Equation 5, according to the development of n2, n3, and n4, an FFT operation may be configured as illustrated in Equation 9.

$$X ( {k}_{1} + 2 {k}_{2} + 4 {k}_{3} + 8 {k}_{4} ) = \begin{matrix}[ \begin{matrix}[ \begin{matrix}\{ x ( 0 ) + ( - 1 ) \text{?} x ( \frac{8 N}{16} ) \} {\text{?}}^{( \frac{N}{4} {n}_{2} )} \\ + {( - 1 )}^{{k}_{2}} \{ x ( \frac{4 N}{16} ) + ( - 1 ) \text{?} x ( \frac{12 N}{16} ) \} {\text{?}}^{( \frac{N}{4} {n}_{2} )}\end{matrix} ] {W}_{N}^{( {k}_{1} + 2 {k}_{2 )} ( \frac{N}{8} {n}_{3} )} \\ + {( - )}^{{k}_{2}} [ \begin{matrix}\{ x ( \frac{2 N}{16} ) + ( - 1 ) \text{?} x ( \frac{10 N}{16} ) \} {\text{?}}^{( \frac{N}{4} {n}_{2} )} \\ + {( - 1 )}^{{k}_{2}} \{ x ( \frac{6 N}{16} ) + ( - 1 ) \text{?} x ( \frac{14 N}{16} ) \} {\text{?}}^{( \frac{N}{4} {n}_{2} )}\end{matrix} ] {W}_{N}^{( {k}_{1} + 2 {k}_{2 )} ( \frac{N}{8} {n}_{3} )}\end{matrix} ] {W}_{N}^{( {k}_{1} + 2 {k}_{2} + 4 {k}_{3} ) ( \frac{N}{16} {n}_{4} )} \\ + {( - 1 )}^{{k}_{4}} [ \begin{matrix}[ \begin{matrix}\{ x ( \frac{N}{16} ) + ( - 1 ) \text{?} x ( \frac{9 N}{16} ) \} {\text{?}}^{( \frac{N}{4} {n}_{2} )} \\ + {( - 1 )}^{{k}_{2}} \{ x ( \frac{5 N}{16} ) + ( - 1 ) \text{?} x ( \frac{13 N}{16} ) \} {\text{?}}^{( \frac{N}{4} {n}_{2} )}\end{matrix} ] {W}_{N}^{( {k}_{1} + 2 {k}_{2 )} ( \frac{N}{8} {n}_{3} )} \\ + {( - )}^{{k}_{2}} [ \begin{matrix}\{ x ( \frac{3 N}{16} ) + ( - 1 ) \text{?} x ( \frac{11 N}{16} ) \} {\text{?}}^{( \frac{N}{4} {n}_{2} )} \\ + {( - 1 )}^{{k}_{2}} \{ x ( \frac{7 N}{16} ) + ( - 1 ) \text{?} x ( \frac{15 N}{16} ) \} {\text{?}}^{( \frac{N}{4} {n}_{2} )}\end{matrix} ] {W}_{N}^{( {k}_{1} + 2 {k}_{2 )} ( \frac{N}{8} {n}_{3} )}\end{matrix} ] {W}_{N}^{( {k}_{1} + 2 {k}_{2} + 4 {k}_{3} ) ( \frac{N}{16} {n}_{4} )}\end{matrix} \qquad Equation 9$$

$$\text{?} \text{indicates text missing or illegible when filed}$$

A signal flow graph 1100 may be configured according to Equation 9. The signal flow graph 1100 illustrates an FFT operation, but a signal flow graph according to an IFFT operation, which is an inverse operation of the FFT operation, may be configured similar to the signal flow graph 1100. For convenience of explanation, the signal flow graph according to the IFFT operation may be described as the signal flow graph 1100.

Referring to the signal flow graph 1100, as an IFFT operation is performed on a symbol sequence (or a symbol) set based on a bit-reversed order, a symbol sequence (or a symbol) set based on a natural bit order may be outputted (or obtained). Since the symbol sequence (or the symbol) is set based on the natural bit order as the IFFT operation is performed, memory for aligning the symbol sequence (or the symbol) (or aligning an FFT index (time domain index)) may not be required. However, memory for performing a cyclic extension operation may be required.

According to an embodiment, the signal flow graph 1100 may include a plurality of stages. For example, the signal flow graph 1100 may include a stage 1101, a stage 1102, a stage 1103, and a stage 1104. An OFDM modulation circuit may perform the operation of Equation 9 by sequentially performing operations related to the stage 1101 to the stage 1104.

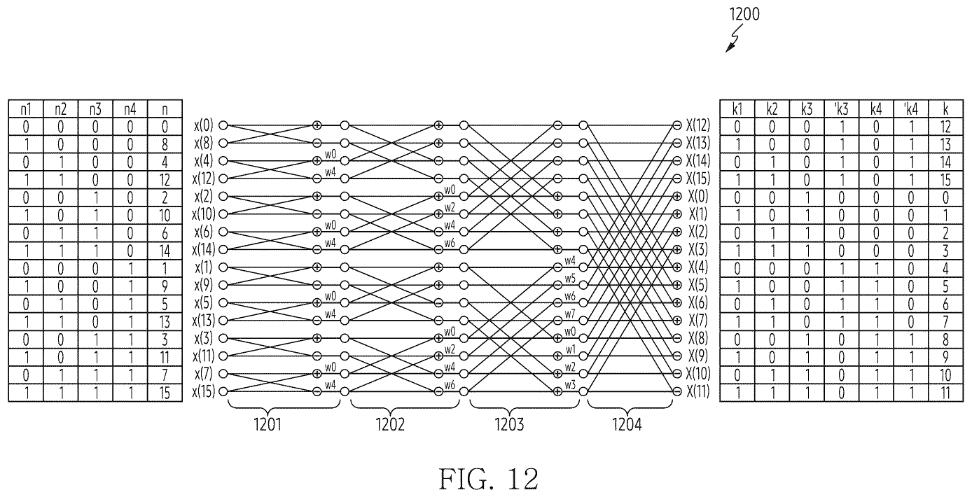

FIG. 12 illustrates a signal flow graph related to an FFT operation for a cyclic extension operation of a DIT FFT structure according to an embodiment of the disclosure.

Referring to FIG. 12, in order to configure an IFFT operation circuit for a cyclic extension operation, in Equation 9 described above, k₃ may be substituted with ‘k₃ and k₄ may be substituted with ‘k₄. For example, ‘k₃ may be configured as illustrated in Equation 10. ‘k₄ may be configured as illustrated in Equation 11.

$$‘ {k}_{3} = ( {n}_{1} + 1 ) mod 2 \qquad Equation 10$$

$$‘ {k}_{4} = ( ( {k}_{3} or {k}_{4} ) + 1 ) mod 2 \qquad Equation 11$$

In Equation 9 described above, a signal flow graph 1200 may be configured according to Equation in which k₃ is substituted with ‘k₃ and k₄ is substituted with ‘k₄.

Referring to FIG. 11, in Equation 9, an operation of the stage 1103 and the stage 1104 according to n4, k1, k2, k3, and k4 may be configured as illustrated in the following table.

TABLE 1

| Addition | | k₂ | k₃ | k₄ | Twiddle | [symbol] | [symbol] [symbol] |
|---|---|---|---|---|---|---|---|
| 0 | 0 | 0 | 0 | 0 | ${W}_{16}^{0}$ | [symbol] | [symbol] |
| 0 | 1 | 0 | 0 | 0 | ${W}_{16}^{0}$ | [symbol] | [symbol] |
| 0 | 0 | 1 | 0 | 0 | ${W}_{16}^{0}$ | [symbol] | [symbol] |
| 0 | 1 | 1 | 0 | 0 | ${W}_{16}^{0}$ | [symbol] | [symbol] |
| 0 | 0 | 0 | 1 | 0 | ${W}_{16}^{0}$ | [symbol] | [symbol] |
| 0 | 1 | 0 | 1 | 0 | ${W}_{16}^{0}$ | [symbol] | [symbol] |
| 0 | 0 | 1 | 1 | 0 | ${W}_{16}^{0}$ | [symbol] | [symbol] |
| 0 | 1 | 1 | 1 | 0 | ${W}_{16}^{0}$ | [symbol] | [symbol] |
| 1 | 0 | 0 | 0 | 1 | ${W}_{16}^{0}$ | [symbol] | [symbol] |
| 1 | 1 | 0 | 0 | 1 | ${W}_{16}^{1}$ | [symbol] | [symbol] |
| 1 | 0 | 1 | 0 | 1 | ${W}_{16}^{2}$ | [symbol] | [symbol] |
| 1 | 1 | 1 | 0 | 1 | ${W}_{16}^{3}$ | [symbol] | [symbol] |
| 1 | 0 | 0 | 1 | 1 | ${W}_{16}^{4}$ | [symbol] | [symbol] |
| 1 | 1 | 0 | 1 | 1 | ${W}_{16}^{5}$ | [symbol] | [symbol] |
| 1 | 0 | 1 | 1 | 1 | ${W}_{16}^{6}$ | [symbol] | [symbol] |
| 1 | 1 | 1 | 1 | 1 | ${W}_{16}^{7}$ | [symbol] | [symbol] |

Referring to Table 1, rows related to the third addition refer to a process of adding (or subtracting) the stage 1103. Rows related to the fourth addition refer to a process of adding (or subtracting) the stage 1104.

Therefore, in a case that k₃ is substituted with ‘k₃ and k₄ is substituted with ‘k₄ in Equation 9, an operation process of the stage 1103 and an operation process of the stage 1104 may be changed.

For example, the addition operation or the subtraction operation of the stage 1103 and the stage 1104 may be changed, and twiddle factors of the stage 1104 may be changed. A stage 1203 and a stage 1204 of the signal flow graph 1200 may be configured based on the addition operation or the subtraction operation of the stage 1103 being changed and the twiddle factors of the stage 1104 being changed.

The signal flow graph 1200 illustrates an FFT operation, but a signal flow graph according to an IFFT operation, which is an inverse operation of the FFT operation, may be configured similar to the signal flow graph 1200. For convenience of explanation, the signal flow graph according to the IFFT operation may be described as the signal flow graph 1200.

Referring to the signal flow graph 1200, in a case that FFT indexes are divided into four groups, a sample (or data) of the last group may be outputted first. Since CP does not exceed 0.25 times an FFT size for all subcarrier spacing (e.g., 15 kHz to 240 kHz), an output of the IFFT operation may be set to easily perform a CP insertion operation (or the cyclic extension operation).

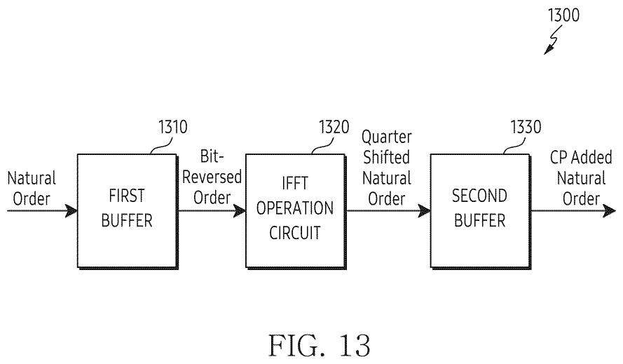

FIG. 13 illustrates an OFDM modulation circuit for performing an IFFT operation for a cyclic extension operation according to an embodiment of the disclosure.

Referring to FIG. 13, an OFDM modulation circuit 1300 may include a first buffer 1310, an IFFT operation circuit 1320, and a second buffer 1330. For example, the first buffer 1310 may correspond to the first buffer 510 of FIG. 5. The IFFT operation circuit 1320 may be configured based on the signal flow graph 1200 of FIG. 12. The second buffer 1330 may be set for a cyclic extension operation (e.g., a CP insertion operation).

In a case that the IFFT operation circuit 1320 is configured based on the signal flow graph 1200 of FIG. 12, as an IFFT operation on a symbol sequence (or a symbol) configured based on a bit-reversed order is performed by the IFFT operation circuit 1320, a symbol sequence (or a symbol) configured based on a natural bit order may be outputted (or obtained) by being circularly shifted by ¼ times of an FFT size.

For example, the first buffer 1310 may be used to perform a cyclic shift operation (or function) and a reordering operation (or function). The reordering operation (or function) may be used to configure a symbol sequence (or symbol) configured based on the bit-reversed order. The first buffer 1310 may be configured to output a symbol sequence in which both the cyclic shift operation (or function) and the reordering operation (or function) are performed.

Since the symbol sequence (or the symbol) is stored in memory (e.g., the first buffer 1310) before being inputted into the IFFT operation circuit 1320, the OFDM modulation circuit 1300 may output (e.g., read) the symbol sequence (or the symbol) stored in the memory (e.g., the first buffer 1310), based on the bit-reversed order, in order to perform the reordering operation (or function). As an example, the OFDM modulation circuit 1300 may set a read address for outputting the symbol sequence (or the symbol) based on the bit-reversed order. The symbol sequence (or the symbol) set according to the bit-reversed order may be inputted into the IFFT operation circuit 1320.

Since CP does not exceed ¼ times the FFT size, in a case that the output circularly shifted by ¼ times of the FFT size is first outputted through the IFFT operation circuit 1320, a size of memory (e.g., the second buffer 1330) for the cyclic extension operation may be reduced. The size of the second buffer 530 of FIG. 5 is set to twice the FFT size, but the size of the second buffer 1330 may be set to ¼ times the FFT size. Therefore, the size of the second buffer 1330 may be set to be ⅛ of the size of the second buffer 530.

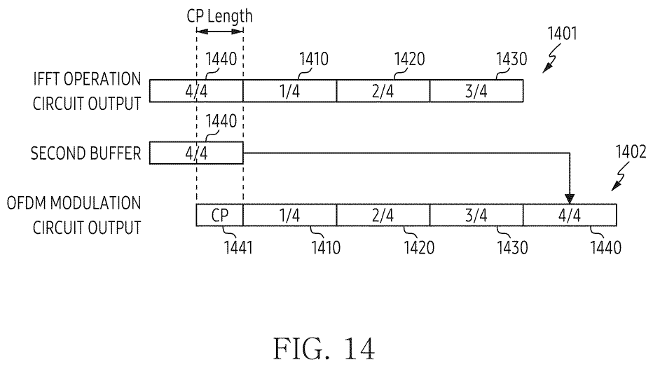

A portion (or data) of the symbol sequence (or the symbol) may be stored in the second buffer 1330 according to an output of the IFFT operation circuit 1320. The portion (or data) of the symbol sequence (or the symbol) is stored in the second buffer 1330 according to the output of the IFFT operation circuit 1320, and an example configured with the output of the OFDM modulation circuit 1300 will be described with reference to FIG. 14.

FIG. 14 illustrates an example of an input and an output for a second buffer according to an embodiment of the disclosure.

Referring to FIG. 14, in an IFFT operation circuit 1320, an IFFT operation for a cyclic extension operation may be performed based on the signal flow graph 1200 of FIG. 12. An output of the IFFT operation circuit 1320 may be set as a signal 1401 (or a symbol). The signal 1401 may be configured based on a time domain. The signal 1401 may include a signal 1410, a signal 1420, a signal 1430, and a signal 1440.

The output of the IFFT operation circuit 1320 may be configured in an order of the signal 1440, the signal 1410, the signal 1420, and the signal 1430. Based on the signal 1440 being outputted from the IFFT operation circuit 1320, a second buffer 1330 may store the signal 1440.

CP 1441 may be configured according to the cyclic extension operation (e.g., a CP insertion operation). For example, the CP 1441 may be configured as a portion of the signal 1440. The portion of the signal 1440 may be configured with the CP 1441, based on a designated time interval. According to a pipelined FFT structure, the CP 1441, the signal 1410, the signal 1420, and the signal 1430 may be sequentially outputted from an OFDM modulation circuit 1300. The OFDM modulation circuit 1300 may not use the second buffer 1330 by outputting the signal 1410, the signal 1420, and the signal 1430, which are outputs of the IFFT operation circuit 1320, as they are.

After outputting the signal 1430, the OFDM modulation circuit 1300 may output the signal 1440 stored in the second buffer 1330. As described above, the OFDM modulation circuit 1300 may output the signal 1402, which is a transmission signal, based on sequentially outputting the CP 1441, the signal 1410, the signal 1420, the signal 1430, and the signal 1440.

As described above, in a case that only ¼ of the signal 1401 is stored in the second buffer 1330, the signal 1402 may be outputted through the OFDM modulation circuit 1300. Therefore, a size of the second buffer 1330 may be set to ⅛ of a size of a second buffer 530. The size of the second buffer 1330 may be set to ¼ of the FFT size.

In the above-described embodiments (e.g., the embodiments of FIGS. 11 to 14), an example in which the FFT size is set to 16 has been described, but this is for convenience of explanation, and the FFT size may be variously set. In addition, the above-described embodiments have been described based on a Radix 2 algorithm, but this is for convenience of explanation. A technical feature according to the above-described embodiments may be applied to various algorithms including a Radix 4 algorithm and a Radix 2\hat{ }2 algorithm.

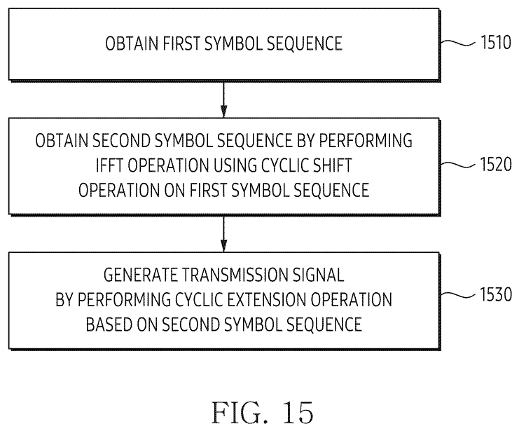

FIG. 15 illustrates a flowchart related to an operation of an electronic device according to a DIF FFT structure according to an embodiment of the disclosure.

Referring to FIG. 15, n operation 1510 to operation 1530, the electronic device may include at least one processing circuit for OFDM modulation that changes a domain of a symbol sequence from a first domain to a second domain. For example, an example of the electronic device according to the operation 1510 to the operation 1530 may be the OFDM modulation circuit 1000 of FIG. 10.

In operation 1510, the at least one processing circuit may obtain a first symbol sequence related to the first domain. For example, the at least one processing circuit may obtain a pre-coded signal. The at least one processing circuit may obtain the first symbol sequence related to the first domain based on the pre-coded signal. As an example, the pre-coded signal may be obtained from another electronic device performing a function of a DU. For example, the first domain may include a frequency domain. The first symbol sequence may be set based on the frequency domain.

For example, the first symbol sequence may be set based on a natural bit order. The first symbol sequence being set based on the natural bit order may mean that an FFT index (or a frequency domain index) is sequentially set. As an example, the first symbol sequence being set based on the natural bit order may mean that the FFT index (or the frequency domain index) is set similar to an input of the signal flow graph 900 of FIG. 9.

In operation 1520, the at least one processing circuit may obtain a second symbol sequence related to the second domain by performing an IFFT operation using a cyclic shift operation on the first symbol sequence.

According to an embodiment, the at least one processing circuit may perform the IFFT operation using the cyclic shift operation on the first symbol sequence. For example, the IFFT operation using the cyclic shift operation may be configured as illustrated in Equation 8 described above.

According to an embodiment, for each FFT index among FFT indexes (or frequency domain indexes) related to the first domain according to an FFT size, the IFFT operation using the cyclic shift operation may include an operation to change a value of the most significant bit (MSB) of a bit sequence of a corresponding FFT index from 0 to 1 or from 1 to 0.

For example, the IFFT operation using the cyclic shift operation may be performed based on a plurality of twiddle factors. A sign of at least one twiddle factor of the plurality of twiddle factors may be changed based on the operation to change the value of the MSB of the bit sequence of the corresponding FFT index from 0 to 1 or from 1 to 0.

The IFFT operation using the cyclic shift operation may be composed of a plurality of operations (or a plurality of stages) based on the plurality of twiddle factors. The plurality of operations may include the stage 901 to the stage 904 of the signal flow graphs of FIG. 9. The at least one twiddle factor in which the sign is changed may be related to a first operation (e.g., the stage 901) of the plurality of operations. As an example, as the sign of the at least one twiddle factor is changed, the first operation of the plurality of operations may be changed similarly to the stage 801 of FIG. 8 being changed to the stage 901 of FIG. 9.

For example, the at least one processing circuit may perform the IFFT operation using the cyclic shift operation on the first symbol sequence without a first buffer for the cyclic shift operation. Since the first symbol sequence is set based on the natural bit order, the first symbol sequence may be sequentially inputted to a circuit (e.g., the IFFT operation circuit 1010 of FIG. 10) configured for the IFFT operation. As an example, the FFT indexes related to the first domain may be sequentially configured. Accordingly, the first buffer for the cyclic shift operation may not be used in the at least one processing circuit. A storage area for the first buffer may not be configured in an electronic device 200 (or the at least one processing circuit).

According to an embodiment, the at least one processing circuit may obtain the second symbol sequence related to the second domain. For example, the at least one processing circuit may obtain the second symbol sequence related to the second domain based on a result of the IFFT operation using the cyclic shift operation. For example, the second domain may include a time domain. The second symbol sequence may be set based on the time domain.

For example, the second symbol sequence may be set based on a bit-reversed order. The second symbol sequence being set based on the bit-reversed order may mean that an FFT index (or a time domain index) is set similar to the output of the signal flow graph 900 of FIG. 9.

In operation 1530, the at least one processing circuit may generate a transmission signal by performing a cyclic extension operation based on the second symbol sequence.

For example, the at least one processing circuit may obtain a transmission signal based on the natural bit order based on the second symbol sequence set based on the bit-reversed order using a second buffer for the cyclic extension operation.

According to an embodiment, a size of the second buffer may be set based on an FFT size. For example, the size of the second buffer may be set to twice the FFT size.

As described above, the at least one processing circuit may obtain the transmission signal set based on the natural bit order based on performing a reordering operation.

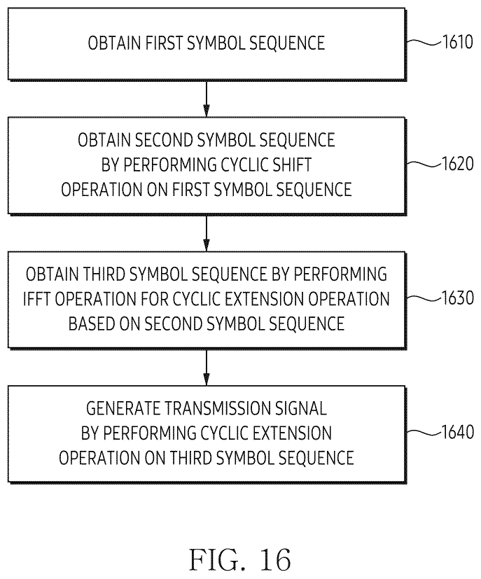

FIG. 16 is a flowchart illustrating an operation of an electronic device according to a decimation in time fast Fourier transform (DIT FFT) structure according to an embodiment of the disclosure.

In operation 1610 to operation 1640, the electronic device may include at least one processing circuit for OFDM modulation that changes a domain of a symbol sequence from a first domain to a second domain. For example, an example of the electronic device according to the operation 1610 to the operation 1640 may be the OFDM modulation circuit 1300 of FIG. 13.

Referring to FIG. 16, in operation 1610, the at least one processing circuit may obtain a first symbol sequence related to a first domain. For example, the at least one processing circuit may obtain a pre-coded signal. The at least one processing circuit may obtain the first symbol sequence related to the first domain based on the pre-coded signal. As an example, the pre-coded signal may be obtained from another electronic device performing a function of a DU. For example, the first domain may include a frequency domain. The first symbol sequence may be set based on the frequency domain.

In operation 1620, the at least one processing circuit may obtain a second symbol sequence by performing a cyclic shift operation on the first symbol sequence. For example, the at least one processing circuit may obtain the second symbol sequence by performing the cyclic shift operation on the first symbol sequence using a first buffer (e.g., the first buffer 1310 of FIG. 13) for the cyclic shift operation. For example, the at least one processing circuit may divide the second symbol sequence into a symbol sequence of a first band and a symbol sequence of a second band. The at least one processing circuit may change positions of the symbol sequence of the first band and the symbol sequence of the second band. The at least one processing circuit may configure a guard band between the symbol sequence of the first band and the symbol sequence of the second band. The at least one processing circuit may perform the cyclic shift operation based on the above-described operation.

In operation 1630, the at least one processing circuit may obtain a third symbol sequence by performing an IFFT operation for a cyclic extension operation based on the second symbol sequence.

For example, the first symbol sequence may be set based on a natural bit order. The second symbol sequence may be set based on a bit-reversed order. The third symbol sequence may be set based on the natural bit order. The second symbol sequence being set based on the bit-reversed order may mean that an FFT index (or a frequency domain index) is set similar to an input of the signal flow graph 1200 of FIG. 12. For example, the at least one processing circuit may obtain the second symbol sequence set based on the bit-reversed order using the first buffer, based on the first symbol sequence set based on the natural bit order. According to an embodiment, the at least one processing circuit may obtain the second symbol sequence from the first symbol sequence based on performing a reordering operation.

According to an embodiment, the at least one processing circuit may obtain the third symbol sequence by performing the IFFT operation for the cyclic extension operation on the second symbol sequence. The third symbol sequence may be set based on the natural bit order.

For example, for each FFT index of FFT indexes (or time domain indexes) related to the second domain according to an FFT size, the IFFT operation for the cyclic extension operation may include an operation to change a value of each of at least one bit of a bit sequence of a corresponding FFT index from 0 to 1 or 1 to 0.

According to an embodiment, the number of the at least one bit of the bit sequence of the corresponding FFT index may be set based on the FFT size. For example, in a case that the FFT size is 16, the number of the at least one bit of the bit sequence of the corresponding FFT index may be set to be 0.25 times the FFT size.

For example, the IFFT operation for the cyclic extension operations may be performed based on a plurality of twiddle factors. At least one twiddle factor of the plurality of twiddle factors may be changed based on the operation to change the value of each of the at least one bit of the bit sequence of the corresponding FFT index from 0 to 1 or from 1 to 0.

The IFFT operation for the cyclic extension operation may be composed of a plurality of operations (or a plurality of stages) based on the plurality of twiddle factors. As an example, the plurality of operations may include the stage 1201 to the stage 1204 of the signal flow graphs of FIG. 12. The at least one twiddle factor changed according to a change for the value of the at least one bit of the bit sequence of the FFT index may be related to a fourth operation (e.g., the stage 1204) of the plurality of operations.

An operation process of a portion of the plurality of operations may be changed according to the change of the value of the at least one bit of the bit sequence of the FFT index. As an example, an operation process (e.g., addition or subtraction) of a third operation (e.g., the stage 1203) and the fourth operation (e.g., the stage 1204) of the plurality of operations may be changed.

In operation 1640, the at least one processing circuit may generate a transmission signal by performing the cyclic extension operation on the third symbol sequence.

According to an embodiment, the at least one processing circuit may perform the cyclic extension operation on the third symbol sequence by using a second buffer for the cyclic extension operation. The at least one processing circuit may generate the transmission signal based on performing the cyclic extension operation on the third symbol sequence by using the second buffer.

For example, the at least one processing circuit may store a portion corresponding to ¼ of the third symbol sequence according to an output of the IFFT operation in the second buffer. The at least one processing circuit may configure, as an output of the at least one processing circuitry (e.g., an OFDM modulation circuit), the output of the IFFT operation from a time point at which a CP period starts among the portion corresponding to ¼ of the third symbol sequence. After the output of the IFFT operation is completed, the at least one processing circuit may output the portion corresponding to ¼ of the symbol sequence stored in the second buffer.

According to an embodiment, a size of the second buffer may be set based on an FFT size. For example, the size of the second buffer may be set to 0.25 times the FFT size.

According to the above-described operation, the at least one processing circuit may perform the cyclic extension operation (CP insertion operation).

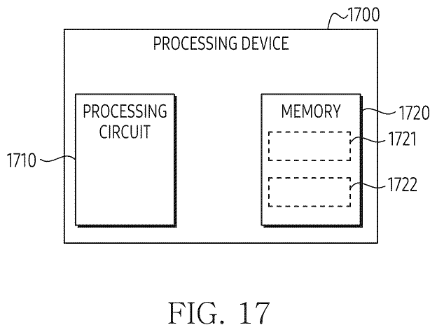

FIG. 17 illustrates an example of a configuration of a processing device according to an embodiment of the disclosure.

Referring to FIG. 17, a processing device 1700 may be configured with one or more chips. For example, the processing device 1700 may be configured with a field programmable gate array (FPGA). For example, the processing device 1700 may be configured based on an application specific integrated circuit (ASIC). For example, an example of the processing device 1700 may be the above-described electronic device (or the OFDM modulation circuit). For example, the processing device 1700 may perform at least some or all of the functions of an RU. However, it is not limited thereto. The processing device 1700 may perform at least some or all of functions of a DU.

For example, the processing device 1700 may be controlled by a processor (or at least a portion of the processor). As an example, the processing device 1700 may be controlled by the processor 380 of FIG. 3B. For example, the processing device 1700 may be configured as the at least a portion of the processor.

According to an embodiment, the processing device 1700 may include a processing circuit 1710 and memory 1720.

For example, an example of the processing circuit 1710 may be the at least one processing circuit of FIGS. 15 and 16. The processing circuit 1710 may include at least one component for OFDM modulation. The processing circuit 1710 may perform an IFFT operation of a DIT FFT structure and/or the DIF FFT structure according to a configuration of the at least one component.

The memory 1720 may include a plurality of storage spaces. The memory 1720 may be divided into the plurality of storage spaces. For example, the memory 1720 may include a first storage space 1721, a second storage space 1722, and/or a third storage space 1723. As an example, the first storage space 1721 may be allocated for the above-described first buffer (e.g., the first buffer 510 of FIG. 5, and the first buffer 1310 of FIG. 13). The second storage space 1722 may be allocated for the above-described second buffer (e.g., the second buffer 530 of FIG. 5, the second buffer 1020 of FIG. 10, and the second buffer 1330 of FIG. 13). According to an embodiment, the memory 1720 may be configured as one memory (or one storage circuit). For example, as a storage space may be divided within one memory, the plurality of storage spaces (e.g., the first storage space 1721, the second storage space 1722, and the third storage space 1723) may be configured. According to an embodiment, the memory 1720 may be configured with a plurality of memories (or a plurality of storage circuits). A first number of memories among the plurality of memories may be used for the first storage space 1721. A second number of memories among the plurality of memories may be used for the second storage space 1722. A third number of memories among the plurality of memories may be used for the third storage space 1723.

At this time, the term ‘˜-unit (or a processor, at least portion of the processor) used in this embodiment refers to software component, or a hardware component such as FPGA or ASIC, and ‘˜unit’ performs certain roles. However, the “˜unit” is not limited in meaning to software or hardware. The “˜unit” may be configured to be located in a storage medium that can be addressed, or may be configured to execute one or more processors. Therefore, as an example, the “˜unit” includes components such as software components, object-oriented software components, class components, and task components, and processes, functions, attributes, procedures, subroutines, segments of program code, drivers, firmware, microcode, circuit, data, database, data structures, tables, arrays, and variables. Functions provided within the components and the “˜units” may be combined into a smaller number of components and “˜units” or further divided into additional components and “˜units”. In addition, the components and “˜units” may be implemented to execute one or more CPUs in a device or a secure multimedia card.

According to an embodiment, an electronic device may comprise memory, and at least one processing circuit for orthogonal frequency division multiplexing (OFDM) modulation to change a domain of a symbol sequence from a first domain to a second domain. The at least one processing circuit may be configured to obtain a first symbol sequence related to the first domain. The at least one processing circuit may be configured to obtain a second symbol sequence related to the second domain by performing an inverse fast Fourier transform (IFFT) operation using a cyclic shift operation on the first symbol sequence. The at least one processing circuit may be configured to generate a transmission signal by performing a cyclic extension operation on the second symbol sequence. For each fast Fourier transform (FFT) index of a plurality of FFT indexes according to an FFT size, the IFFT operation using the cyclic shift operation may comprise an operation to change a value of the most significant bit (MSB) of a bit sequence of a corresponding FFT index from 0 to 1 or 1 to 0.

For example, the IFFT operation using the cyclic shift operation may be performed based on a plurality of twiddle factors. A sign of at least one twiddle factor of the plurality of twiddle factors may be changed based on the operation to change the value of the most significant bit (MSB) of the bit sequence of the corresponding FFT index from 0 to 1 or 1 to 0.

For example, the IFFT operation using the cyclic shift operation may be composed of a plurality of operations based on the plurality of twiddle factors. The at least one twiddle factor may be related to a first operation of the plurality of operations.

For example, the first symbol sequence may be set based on a natural bit order. The second symbol sequence may be set based on a bit-reversed order.

For example, the at least one processing circuit may be configured to perform the IFFT operation using the cyclic shift operation on the first symbol sequence without a first buffer for the cyclic shift operation.

For example, the at least one processing circuit may be configured to obtain the transmission signal which is set based on the natural bit order, based on the second symbol sequence set based on the bit-reversed order.

For example, a size of the second buffer may be set to twice the FFT size.

According to an embodiment, a method of an electronic device may comprise obtaining a first symbol sequence related to a first domain. The method may comprise obtaining a second symbol sequence related to a second domain by performing an inverse fast Fourier transform (IFFT) operation using a cyclic shift operation on the first symbol sequence. The method may comprise generating a transmission signal by performing a cyclic extension operation on the second symbol sequence. For each fast Fourier transform (FFT) index of a plurality of FFT indexes according to an FFT size, the IFFT operation using the cyclic shift operation may comprise an operation to change a value of the most significant bit (MSB) of a bit sequence of a corresponding FFT index from 0 to 1 or 1 to 0.

For example, the IFFT operation using the cyclic shift operation may be performed based on a plurality of twiddle factors. A sign of at least one twiddle factor of the plurality of twiddle factors may be changed based on the operation to change the value of the most significant bit (MSB) of the bit sequence of the corresponding FFT index from 0 to 1 or 1 to 0.

For example, the IFFT operation using the cyclic shift operation may be composed of a plurality of operations based on the plurality of twiddle factors. The at least one twiddle factor may be related to a first operation of the plurality of operations.

For example, the first symbol sequence may be set based on a natural bit order. The second symbol sequence may be set based on a bit-reversed order.

For example, the method may comprise performing the IFFT operation using the cyclic shift operation on the first symbol sequence without a first buffer for the cyclic shift operation.

For example, the method may comprise obtaining a transmission signal which is set based on the natural bit order, based on the second symbol sequence set based on the bit-reversed order.

For example, a size of the second buffer may be set to twice the FFT size.

According to an embodiment, an electronic device may comprise memory, and at least one processing circuit for orthogonal frequency division multiplexing (OFDM) modulation to change a domain of a symbol sequence from a first domain to a second domain. The at least one processing circuit may be configured to obtain a first symbol sequence related to the first domain. The at least one processing circuit may be configured to obtain a second symbol sequence by performing a cyclic shift operation on the first symbol sequence. The at least one processing circuit may be configured to obtain a third symbol sequence related to the second domain by performing an inverse fast Fourier transform (IFFT) operation for a cyclic extension operation based on the second symbol sequence. The at least one processing circuit may be configured to generate a transmission signal by performing the cyclic extension operation on the third symbol sequence. For each fast Fourier transform (FFT) index of a plurality of FFT indexes according to an FFT size, the IFFT operation for the cyclic extension operation may comprise an operation to change a value of each of at least one bit of a bit sequence of a corresponding FFT index from 0 to 1 or 1 to 0.

For example, the number of the at least one bit of the bit sequence of the corresponding FFT index may be set based on the FFT size.

For example, the IFFT operation for the cyclic extension operation may be performed based on a plurality of twiddle factors. At least one twiddle factor of the plurality of twiddle factors may be changed based on the operation to change the value of each of the at least one bit of the bit sequence of the corresponding FFT index from 0 to 1 or 1 to 0.

For example, the at least one processing circuit may be configured to obtain the second symbol sequence by performing the cyclic shift operation on the first symbol sequence using a first buffer for the cyclic shift operation, which is allocated in the memory.

For example, the at least one processing circuit may be configured to obtain the second symbol sequence set based on a bit-reversed order using the first buffer.

For example, the third symbol sequence may be set based on a natural bit order.

For example, the at least one processing circuit may be configured to generate the transmission signal by performing the cyclic extension operation on the third symbol sequence using a second buffer for the cyclic extension operation, which is allocated in the memory.

For example, a size of the second buffer may be set to 0.25 times the FFT size.

According to an embodiment, a buffer for an input and an output of a pipelined FFT may be included in an OFDM modulation circuit. For example, a first buffer may be used (or configured) for the input of the pipelined FFT. The second buffer may be used (or configured) for the output of the pipelined FFT. Memory having a depth twice an FFT size (or a size of an FFT point) may be used for the input (or the output) of the pipelined FFT. According to the above-described embodiment, through a simple change of an equation, an input buffer may not be used, or a size of an output buffer may be reduced, without performance degradation. According to the above-described embodiment, since a storage procedure is simplified, a latency of an OFDM symbol or more may be reduced. According to the above-described embodiment, as hardware resource usage is reduced, heat generation and power consumption may be reduced. Since an IFFT operation should be performed per antenna in the OFDM modulation circuit, in a system having a large bandwidth and a large number of antennas, heat generation and power consumption may be significantly reduced.

Methods according to embodiments described in claims or specifications of the disclosure may be implemented as a form of hardware, software, or a combination of hardware and software.

In a case of implementing as software, a computer-readable storage medium for storing one or more programs (software module) may be provided. The one or more programs stored in the computer-readable storage medium are configured for execution by one or more processors in an electronic device. The one or more programs include instructions that cause the electronic device to execute the methods according to embodiments described in claims or specifications of the disclosure. The one or more programs may be included and provided in a computer program product.

The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. In the case of being distributed online, at least part of the computer program product may be temporarily generated or at least temporarily stored in the machine-readable storage medium, such as memory of the manufacturer's server, the application store's server, or a relay server.

Such a program (software module, software) may be stored in a random access memory, a non-volatile memory including a flash memory, a read only memory (ROM), electrically erasable programmable read only memory (EEPROM), a magnetic disc storage device, an optical storage device (e.g., a compact disc-ROM (CD-ROM), digital versatile discs (DVDs), or other formats), or a magnetic cassette. Alternatively, it may be stored in memory configured with a combination of some or all of them. In addition, a plurality of configuration memories may be included.

Additionally, a program may be stored in an attachable storage device that may be accessed through a communication network such as the Internet, Intranet, local area network (LAN), wide area network (WAN), or storage area network (SAN), or a combination thereof. Such a storage device may be connected to a device performing an embodiment of the disclosure through an external port. In addition, a separate storage device on the communication network may also be connected to a device performing an embodiment of the disclosure.

In the above-described specific embodiments of the disclosure, components included in the disclosure are expressed in the singular or plural according to the presented specific embodiment. However, the singular or plural expression is selected appropriately according to a situation presented for convenience of explanation, and the disclosure is not limited to the singular or plural component, and even components expressed in the plural may be configured in the singular, or a component expressed in the singular may be configured in the plural.

According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be executed sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory; and
at least one processing circuit for orthogonal frequency division multiplexing (OFDM) modulation to change a domain of a symbol sequence from a first domain to a second domain,
wherein the at least one processing circuit is configured to:
obtain a first symbol sequence related to the first domain,
obtain a second symbol sequence related to the second domain by performing an inverse fast Fourier transform (IFFT) operation using a cyclic shift operation on the first symbol sequence, and
generate a transmission signal by performing a cyclic extension operation on the second symbol sequence, and
wherein, for each fast Fourier transform (FFT) index of a plurality of FFT indexes according to an FFT size, the IFFT operation using the cyclic shift operation comprises an operation to change a value of the most significant bit (MSB) of a bit sequence of a corresponding FFT index from 0 to 1 or 1 to 0.

2. The electronic device of claim 1,
wherein the IFFT operation using the cyclic shift operation is performed based on a plurality of twiddle factors, and
wherein a sign of at least one twiddle factor of the plurality of twiddle factors is changed based on the operation to change the value of the most significant bit (MSB) of the bit sequence of the corresponding FFT index from 0 to 1 or 1 to 0.

3. The electronic device of claim 2,
wherein the IFFT operation using the cyclic shift operation is composed of a plurality of operations based on the plurality of twiddle factors, and
wherein the at least one twiddle factor is related to a first operation of the plurality of operations.

4. The electronic device of claim 1,
wherein the first symbol sequence is set based on a natural bit order, and
wherein the second symbol sequence is set based on a bit-reversed order.

5. The electronic device of claim 4, wherein the at least one processing circuit is further configured to perform the IFFT operation using the cyclic shift operation on the first symbol sequence without a first buffer for the cyclic shift operation.

6. The electronic device of claim 5, wherein the at least one processing circuit is further configured to obtain the transmission signal which is set based on the natural bit order, based on the second symbol sequence set based on the bit-reversed order.

7. The electronic device of claim 6, wherein a size of a second buffer is set to twice the FFT size.

8. A method performed by an electronic device, the method comprising:
obtaining, by the electronic device, a first symbol sequence related to a first domain;
obtaining, by the electronic device, a second symbol sequence related to a second domain by performing an inverse fast Fourier transform (IFFT) operation using a cyclic shift operation on the first symbol sequence; and
generating, by the electronic device, a transmission signal by performing a cyclic extension operation on the second symbol sequence,
wherein, for each fast Fourier transform (FFT) index of a plurality of FFT indexes according to an FFT size, the IFFT operation using the cyclic shift operation comprises an operation to change a value of the most significant bit (MSB) of a bit sequence of a corresponding FFT index from 0 to 1 or 1 to 0.

9. The method of claim 8,
wherein the IFFT operation using the cyclic shift operation is performed based on a plurality of twiddle factors, and
wherein a sign of at least one twiddle factor of the plurality of twiddle factors is changed based on the operation to change the value of the most significant bit (MSB) of the bit sequence of the corresponding FFT index from 0 to 1 or 1 to 0.

10. The method of claim 9,
wherein the IFFT operation using the cyclic shift operation is composed of a plurality of operations based on the plurality of twiddle factors, and
wherein the at least one twiddle factor is related to a first operation of the plurality of operations.

11. The method of claim 8,
wherein the first symbol sequence is set based on a natural bit order, and
wherein the second symbol sequence is set based on a bit-reversed order.

12. The method of claim 11, wherein the method further comprises performing the IFFT operation using the cyclic shift operation on the first symbol sequence without a first buffer for the cyclic shift operation.

13. The method of claim 12, wherein the method further comprises obtaining a transmission signal which is set based on the natural bit order, based on the second symbol sequence set based on the bit-reversed order.

14. The method of claim 13, wherein a size of a second buffer is set to twice the FFT size.

15. The method of claim 8,
wherein the first domain includes a frequency domain, and
wherein the second domain includes a time domain.

16. One or more non-transitory computer-readable storage media storing one or more computer programs including computer-executable instructions that, when executed by one or more processors of an electronic device individually or collectively, cause the electronic device to perform operations, the operations comprising:
obtaining, by the electronic device, a first symbol sequence related to a first domain;
obtaining, by the electronic device, a second symbol sequence related to a second domain by performing an inverse fast Fourier transform (IFFT) operation using a cyclic shift operation on the first symbol sequence; and
generating, by the electronic device, a transmission signal by performing a cyclic extension operation on the second symbol sequence,
wherein, for each fast Fourier transform (FFT) index of a plurality of FFT indexes according to an FFT size, the IFFT operation using the cyclic shift operation comprises an operation to change a value of the most significant bit (MSB) of a bit sequence of a corresponding FFT index from 0 to 1 or 1 to 0.

17. The one or more non-transitory computer-readable storage media of claim 16,
wherein the IFFT operation using the cyclic shift operation is performed based on a plurality of twiddle factors, and
wherein a sign of at least one twiddle factor of the plurality of twiddle factors is changed based on the operation to change the value of the most significant bit (MSB) of the bit sequence of the corresponding FFT index from 0 to 1 or 1 to 0.

18. The one or more non-transitory computer-readable storage media of claim 17,
wherein the IFFT operation using the cyclic shift operation is composed of a plurality of operations based on the plurality of twiddle factors, and
wherein the at least one twiddle factor is related to a first operation of the plurality of operations.

19. The one or more non-transitory computer-readable storage media of claim 16,
wherein the first symbol sequence is set based on a natural bit order, and
wherein the second symbol sequence is set based on a bit-reversed order.

20. The one or more non-transitory computer-readable storage media of claim 19, the operations further comprise performing the IFFT operation using the cyclic shift operation on the first symbol sequence without a first buffer for the cyclic shift operation.
